(19) United States
(12) Patent Application Publication
(10) Pub. No.: US 2012/0089481 A1
(43) Pub. Date: Apr. 12, 2012

(54) SECURING SENSITIVE INFORMATION WITH A TRUSTED PROXY FRAME

(75) Inventors: Salvatore F. Iozzia, Decatur, GA (US); Gregory P. McGraw, Marietta, GA (US); Michael G. Fuller, Atlanta, GA (US); Evan M. Ruff, Atlanta, GA (US)

(73) Assignee: CHAIN REACTION ECOMMERCE, INC., Atlanta, GA (US)

(21) Appl. No.: 12/954,342

(22) Filed: Nov. 24, 2010

Related U.S. Application Data
(60) Provisional application No. 61/264,202, filed on Nov. 24, 2009.

(51) Int. Cl. H04L 9/32; G06Q 30/00; G06F 21/00

(52) U.S. Cl. 705/26.41; 726/3; 726/5

(57) ABSTRACT

A system and method for secure transmission of sensitive end user information from an Internet portal operated by a publisher to a third party data processor. The publisher provides a content portal such as an e-commerce or healthcare information site. A third party data processor such as a bank or healthcare organization requires the sensitive information for a data processing function. In response to the requirement for sensitive information, a trusted proxy frame is invoked from a secure server operative to securely communicate the sensitive information. The trusted proxy frame is displayed in a secure context in the end user's browser and receives input of the sensitive information. The sensitive information is encrypted and communicated through the secure server to the third party data processor. Results of this processing are transmitted to the publisher through a novel callback process that enables the publisher to execute its data processing functions, as if it was in possession of the sensitive information, but without actual access to the sensitive information. The third party data processor returns an acknowledgement of processing of the sensitive information.

### CROSS REFERENCE TO RELATED APPLICATION

This application claims the benefits of and priority to U.S. Provisional Patent Application No. 61/264,202, filed Nov. 24, 2009, which is incorporated herein by reference as if made a part hereof, under 35 U.S.C. §119(e).

### TECHNICAL FIELD

Briefly described, the present invention(s) generally relate to aspects of systems and methods for preventing unlawful intercept and/or access to sensitive user data in a networked computing environment. More particularly described, aspects of the present invention(s) allow parties using the system to comply with policies for handling sensitive data of end users in an Internet environment, and enabling such parties to obtain sensitive data from the end users and provide that sensitive data to third party data processors without exposing the sensitive data to excessive risk of unauthorized disclosure, theft or tampering.

### BACKGROUND

Presently known systems for exchanging information and content in an unsecured network setting, such as on the Internet, present risks to various parties from the possibility of interception and/or tampering of private information, such as credit card numbers, financial information, account numbers, personal identifying information, healthcare information, and other information that network users require to be maintained in privacy. The risks of identity theft and compromised transactions has increased due to the world-wide nature and extent of the unsecured Internet, and the relative obscurity with which information thieves and criminal can operate.

In an exemplary configuration of an Internet e-commerce exchange, a customer (an “End User”) of an online merchant provides sensitive personal information (“Primary Information”) such as a payment information to complete a purchase transaction with an online merchant (one type of “Publisher” as the term is used herein). Examples of submitted Primary Information include credit card numbers, card expiration dates, Card Validation Codes (CVC2), and other similar information. Typically, a Publisher creates a reserved frame integrated within the site's “shopping cart” purchase interface in order for the End User to input his or her payment information. However, the merchant (more generally, any Publisher) may be in at least temporary possession of the sensitive information as it is passed to another system (e.g. a bank or credit card approval system), which creates an opportunity for compromise if the merchant's system is not itself secure or has been compromised.

In a second exemplary configuration of a healthcare service, a medical patient as End User provides Primary Information to a field healthcare clinic (also a type of Publisher as the term is used herein). Exemplary Primary Information includes Social Security numbers, insurance policy identifiers, and diagnosis codes. The field healthcare clinic-type Publisher then submits the Primary Information to a parent organization, such as a hospital, that aggregates patient information from multiple clinics. The field healthcare clinic Publisher and hospital also submits Primary Information to a Third-Party Processor, such as an insurance company, for purposes of claim submission and financial reimbursement.

Once submitted to the Publisher, Primary Information may be vulnerable to criminal access when it is entered, transmitted or stored. For example, a criminal may have a method to intercept Primary Information when it is entered on an application interface or transmitted across the Publisher's internal computer network. Exploits may include methods such as “Trojan horse” computer programs installed on Publisher transactional applications and “packet sniffer” programs that retrieve Primary Information contained within IP network traffic or similar methods. Alternately, a criminal may illegally access and retrieve Primary Information contained within a Publisher's backend computer system and storage media. Such illegal access may be obtained by computer network penetration (“hacking”) from a remote system, insider access, extortion or similar methods.

Once the criminal is in possession of stolen Primary Information, they may use or sell the information to make fraudulent purchases, perpetrate identity theft and/or commit other crimes. In the example of online credit card fraud, such criminal activity is estimated to incur multibillion-dollar losses for financial institutions and Publishers worldwide. Theft of Primary Information can also result in legal liability, negative publicity, damage goodwill or other consequences.

In many cases, criminal access to Third-Party Data Processing Information can be prevented through the use of information security devices, rigorous operational procedures and other methods. For example, but not by way of limitation, the PCI DSS framework developed by the PCI Security Standards Council is an example of a consistent, verifiable policy framework for safeguarding Primary Information. The PCI DSS is a multifaceted security standard that includes requirements for security management, policies, procedures, network architecture, software design and other critical protective measures. This comprehensive standard is intended to help organizations proactively protect sensitive customer data. The PCI DSS-mandated processes may be implemented and maintained by Publishers, Third Party Processors, independent agents or others.

A Publisher can become compliant with internal or externally-mandated policies for Primary Information controls by implementing the designated standards on their in-house technology infrastructure. This approach allows them to use their native transactional applications, which may enable unique functionality and/or enhance their interaction with an End-User.

Unfortunately, ongoing policy compliance may present impractical or unreasonable technical, administrative and financial burdens for Publishers. This may prevent a Publisher from successfully implementing and maintaining standards for handling Primary Information. An incomplete standards implementation may create a false sense of security. Ultimately, the Publisher may experience theft of Primary Information, fraud, liability, negative publicity or other consequences.

Conventional Primary Information controls may also prevent or compromise desirable Publisher application functionality. This may require unattractive trade-offs between application performance, application security, and/or other factors. For example, but not by way of limitation, optimal functionality in a Publisher web application may be blocked by the implementation of conventional application security measures, such as user authentication, cross-site scripting controls, cookie security or disablement of scripting and active code.

Alternately, Publishers may choose to outsource Primary Information handling to a third-party that maintains a trusted host infrastructure. For example, but not by way of limitation, an online Publisher may relay an End User transaction session in real-time via a networked trusted host. The trusted host executes the Primary Information transaction in a manner compliant with predetermined instructions and then returns the End User via electronic network to the Publisher. This approach relieves the Publisher of direct responsibility for Primary Information controls.

Unfortunately, the process of relaying the customer from the Publisher to the third-party trusted host may degrade functional attributes of Publisher applications. For example, but not by way of limitation, the aesthetics of an online merchant shopping cart page and the overall customer experience may be significantly degraded when the End User customer is transferred to the trusted host. Additionally, there may be ongoing operational fees associated with the third-party trusted host that negatively impact Publisher profitability and viability.

There is a need for a novel system that enables a distrusted Primary Function to mediate trusted Primary Information transactions, between a plurality of Internet domains and endpoints, without compromising Primary Function operational characteristics in the associated user transaction session. The required solution must integrate with a distrusted Primary Function in a manner that is functionally transparent to authorized End Users and Secondary Function agents in the transaction session. The solution needs the ability to authenticate endpoints and mediate authorized cross domain communication without jeopardizing Primary Information integrity and domain segmentation.

### SUMMARY OF THE INVENTION

In summary, the present inventions are embodied as systems, methods, and computer program products that obtain sensitive user information such as personal identifying information or healthcare information from end users, who are accessing a publisher's system (e.g. an online merchant, a healthcare services provider, or other entity that provides a computing function that requires the user's sensitive information), in an environment that requires a third party data processor to have access to the sensitive information but there is a need to protect the sensitive information from the computing environment of the publisher. According to one aspect, the invention(s) relate to a system and or method for providing a trusted computing function of a third party data processor on behalf of a networked publisher in connection with providing a networked computing function for an end user by the publisher, where the third party data processor requires sensitive information of an end user. In such an environment, the publisher may be operating a distrusted server coupled to a data communication network, and the distrusted server includes a distrusted end user interface, a processor for executing computer program modules and a memory.

According to an aspect of the inventions, the system and method comprises a secure server coupled to the data communications network. A data communications interface is provided for trusted communications between the distrusted server of the publisher and an end user, trusted communications between the distrusted server of the publisher and the secure server, and trusted communications between the secure server and the third party data processor. A security function computer program module executable on the secure server is provided, the security function program module being operative to carry out various processing steps designed to protect the sensitive information. The security function program module is operative to receive an incoming communication (URL submission) from a calling function computer program module of the publisher via the data communications interface, and receive an incoming communication from the publisher via the data communications interface, the incoming communication including contemporary specific attribute parameters of the calling function computer program module of the publisher. Thereafter, the security function program module is operative to execute a trusted transaction interface function computer program module on the secure server to create a trusted user interface computer program module executable on an end user's computer (e.g. a JavaScript object). The security function program module is also operative to send an outgoing communication from the security function computer program module to the publisher via the data communications interface, the outgoing communication including the trusted user interface computer program module (e.g. the JavaScript object), the calling function computer program module of the publisher receiving the trusted user interface computer program module and merging the trusted user interface computer program module with its distrusted end user interface.

The secure server is further operative to launch an authentication validation function receiver computer program module on the secure server to ensure secure communications with the trusted user interface computer program module (e.g. JavaScript object) when executing on the end user's computer. The security function program module is still further operative to launch an authentication validation function sender computer program module on the trusted user interface computer program module at the end user's computer to ensure secure communications with the secure server.

At periodic intervals, the security function program module is operative to send an outgoing communication from the authentication validation function sender computer program module on the trusted user interface computer program module to the authentication validation function receiver computer program module on the secure server via the data communications interface, the outgoing communication including a request for contemporary specific attribute parameters of the trusted user interface computer program module.

The foregoing operations establish what may be termed as a secure signaling channel whereby the end user may safely provide his or her sensitive information. The system and method then is operative to execute the trusted user interface function computer program module to receive the sensitive information input by the end user. The security function program module is the operative to execute a transaction processing function computer process module of the secure server to receive the sensitive information from the trusted user interface computer program module and provide the sensitive information to the third party data processor.

In response to the third party data processor's operations with the sensitive information, the security function program module is operative to execute a third party data communication function computer program module on the secure server to receive results data from the third party data processor. The security function program module is then operative to execute a signaling function computer program module on the secure server to process the results data. The security function program module is then operative to execute a transaction completion function computer program module on the secure server in response to said results data indicating completion of the third party data processing function. This completion may indicate satisfactory processing of the sensitive data, or may indicate an error condition. The security function program module is then, and finally, operative to send non-sensitive results data from the secure server to the trusted user interface computer program module and then to the distrusted end user interface of the publisher.

In this manner, the sensitive information is protected from access by possibly compromised aspects or elements of the publisher's system or computing environment.

According to another aspect, a system, method, and/or computer program product as described herein solves the need for a distrusted Primary Function to safely mediate Primary Information transactions between a plurality of Internet domains and endpoints, without compromising Primary Function operational characteristics in the associated user transaction session. For example, but not by way of limitation, the system enables a distrusted web e-commerce application (Primary Function) to collect sensitive credit card data (Primary Information) and mediate a secure transaction between a End User and a credit card processor in a manner that complies with a designated security protocol, such as PCI DSS.

According to an aspect, there is provided a system that creates a Trusted Proxy Frame hosted within a secure remote hosting facility. According to another aspect of the system, a Trusted Proxy Frame is known as a Remote Domain Frame. When an End User initiates a purchase transaction within the Publisher shopping cart, the Publisher applications signals a request for the Trusted Proxy Frame. The Trusted Proxy Frame is dynamically created at the secure remote hosting facility, transmitted across a network connection and transparently inserted into the reserved frame created within the shopping cart interface. The End User enters Primary Information into the Trusted Proxy Frame, also known as a Remote Domain Frame, which then electronically transmits the End User's Primary Information to a Third-Party Processor. An example of a Third-Party Processor includes an entity that mediates payment card transactions between a Publisher and a financial institution such as a merchant bank. The Third-Party Processor provides notification if the payment card transaction is approved or denied. These results are signaled back to elements of the Trusted Proxy Frame, and approved purchase requests are also forwarded to the Publisher Bank. Ultimately, the Publisher Bank issues funds that are received as transaction payment by the Publisher.

The system facilitates policy-compliant collection, processing and presentation of sensitive user data while maintaining the aesthetic and functional integrity of associated non-compliant computer systems and networks.

The system uses a trusted data collection element embedded within a distrusted user interface. For example, but not by way of limitation, an e-commerce payment page. The trusted data collection element is hosted in a policy-compliant remote computing facility. The system deploys the trusted data collection element on demand to the distrusted payment page. The system then transparently integrates the trusted data collection element within the distrusted payment page.

The trusted data collection element presents a user interface to input sensitive user data. The trusted element then mediates the exchange of the sensitive user data with Third-Party Processors. The element then handles the Third-Party Processor response and presents parsed results to the Publisher and the end user.

Examples of sensitive user data include credit card numbers, electronic health records and Social Security numbers. Exemplary Publishers include online merchants, insurance companies, securities brokers and medical treatment facilities. Examples of policy for sensitive user data include those defined under The Health Insurance Portability and Accountability Act (HIPAA) and the PCI Data Security Standard (PCI DSS) protocol developed by the PCI Security Standards Council. Examples of Third-Party Processors include merchant banks, credit card processors and insurance agencies.

The system provides the advantage of being in embeddable as a function within a distrusted Primary Function so that system functions are functionally transparent to authorized End Users and Secondary Function agents in a transaction session. For example, but not by way of limitation, software code of the system may be embedded in a distrusted web application so that system operations, such as proxy frame presentation and endpoint authentication, are functionally transparent to a human user and/or third-party processor applications.

The system enables Publishers to quickly deploy policy enforcement methods without introducing unreasonable compromises to the functional attributes of applications that interface with Primary Information. For example, but not by way of limitation, a Publisher such as an online merchants or insurance company can integrate trusted functionality with a distrusted legacy application without requiring significant application changes.

The system allows a Publisher to outsource primary information policy enforcement responsibilities from a Primary Function to a Secure Server without materially compromising the functionality or user experience of the Primary Function. For example, but not by way of limitation, an insecure web application could transparently outsource credit card handling procedures to a secure server so that the active end user would not be aware of process and interface handoffs between an insecure web application and a secure server.

The system creates, on demand, a trusted user interface software device (“Trusted Proxy Frame”) in a trusted computing environment (“Secure Server”). According to another aspect of the system, the Trusted Proxy Frame is known as a Remote Domain Frame. The system retrieves the Trusted Proxy Frame from the Secure Server and inserts it into a designated container within the Publisher application interface. For example, but not by way of limitation, a designated container may be an iFrame HTML construct in an HTML-based user interface for an e-commerce shopping cart.

The system has the ability to transparently vary the active source and method of communication so that trusted components may be aesthetically and functionally integrated with distrusted components while maintaining logical segregation. For example, but not by way of limitation, the End User interface for a credit card transaction may include a trusted card data collection form, flanked by distrusted graphical elements of the e-commerce shopping cart. To the user, the trusted and distrusted elements appear to be functionally and aesthetically integrated. However, the system may access trusted and distrusted elements using different sources and protocols and enforce logical separation when the elements are assembled for user presentation.

The system authenticates a plurality of endpoints in a Primary Information transaction and mediates authorized cross-domain communication while maintaining Primary Information integrity and domain segmentation. For example, but not by way of limitation, the system can authenticate an end user and a secure server and mediate a Primary Information transaction between their respective domains while preserving information and domain security.

The system provides a method to make Primary Information accessible to authorized agents. For example, but not by way of limitation, an authorized agent may include an insurance company that processes electronic health data.

The system provides the advantage of allowing a Publisher to safely initiate and mediate Primary Information transactions that may include an End User, a Secondary Function, a Third Party Processor, and a distrusted Primary Function, without requiring extensive changes to the Primary Function or the End User transaction experience. By example, but not by way of limitation, this can provide legal, technical, commercial, financial or operational benefits to the End User, Publisher, and/or Third-Party Processor.

The invention is not limited to the proceeding and it will be further understood by reference to the following detailed description and the appended drawings and claims.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWING FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a system diagram illustrating a trusted proxy frame, also known as a remote domain frame, and key elements in its environment.

FIG. 2 is a system diagram illustrating key elements and process flows that launch and interoperate with a trusted proxy frame.

FIG. 3 is a system diagram illustrating key elements and process flows of a parent frame with an embedded local first child frame.

FIG. 4 is a system diagram illustrating key elements and process flows of a first child frame with embedded remote second child frame.

FIG. 5, consisting of FIG. 5A through 5H, illustrates key elements and process flows of a second child frame with local content.

FIG. 6, consisting of FIG. 6A through 6E, is a system diagram illustrating key elements and process steps of an authentication key exchange.

FIG. 7 is a system diagram illustrating key elements and process flows of three different key request chain scenarios.

FIG. 8 illustrates a display screen showing a parent frame with embedded child frames in accordance with an aspect of the invention(s).

FIG. 9 illustrates a callback process in accordance with an aspect of the invention(s).

FIG. 10 illustrates another display screen showing a parent frame with embedded child frames in accordance with an aspect of the invention(s).

FIG. 11 illustrates an embedded trusted proxy frame in accordance with an aspect of the invention(s).

FIG. 12 illustrates an trusted proxy frame with callback in accordance with an aspect of the invention(s).

FIG. 13 illustrates a nested hierarchy around a trusted proxy frame in accordance with an aspect of the invention(s).

FIG. 14 illustrates the transformation of Primary Information in accordance with an aspect of the invention(s).

### DETAILED DESCRIPTION OF EMBODIMENTS OF THE INVENTIONS

Prior to a detailed description of the disclosure, the following definitions are provided as an aid to understanding the subject matter and terminology of aspects of the present systems and methods, are exemplary, and not necessarily limiting of the aspects of the systems and methods, which are expressed in the claims. Whether or not a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### DEFINITIONS

ACH (Automated Clearing House): The ACH is a secure computer network that efficiently connects individuals, businesses, and banks together through the Federal Reserve System enabling electronic payments to flow safely from start to finish.

Application Server: A computing framework dedicated to the specialized execution of designated procedures. For example, but not by way of limitation, a physical computer running the Apache Software Foundation's Apache Web Server, configured to house and enable Web-based content and applications.

Authorization: A process whereby a transaction is approved by an issuing bank, authorized agent, or Visa/MasterCard on behalf of that issuer, before the transaction is completed by the merchant via telephone or terminal.

Authentication Key: A digital key employed to ensure that data exchanged during an electronic commerce transaction remains unchanged, and cannot be interfered-with by any unauthorized third party. For example, but not by way of limitation, an SSH key or an electronic key that embodies unique attributes of the transaction it authenticates and secures.

Card Issuer: A card issuer is a bank or financial institution that provides “card association” branded payment (credit or debit) cards directly to consumers.

Card Security Code (CSC): Also known as Card Verification Value (CVV or CV2), Card Verification Value Code (CVVC), Card Verification Code (CVC), Verification Code (V-Code or V Code), or Card Code Verification (CCV). CSC is a security feature for credit or debit card transactions, giving increased protection against credit card fraud.

Content Collection Form: A user interface element designated for data entry. For example, but not by way of limitation, the credit card submission form of an e-commerce website or the user ID/password fields of an application logon dialog.

Credit Card Processing: Credit card processing is a complex series of electronic events that accomplishes the secure, successful transfer of funds from a bank to a merchant in payment for goods and services purchased by a valid credit card holder.

Credit Card Processors: Credit card processors are businesses, including but not limited to chartered financial institutions, that give merchants the ability to accept debit and credit card payments for goods and services.

Credit Card: A credit card is a thin plastic card, roughly three by two inches in size, which is used by consumers and companies to make purchases.

Cross-Site Scripting: A type of computer security vulnerability, such as in an Internet application context, which enables malicious attackers to inject client-side scripts into otherwise benign and trusted web sites. For example, but not by way of limitation, computer security exploits enabled by cross site scripting include circumvention of access controls, impersonation of a trusted entity or data interception and redirection.

CVV1: also known as CVC1. A character string encoded on the magnetic stripe of a credit or debit card and used for transactions in person.

CVV2: A three or four digit value printed on a payment card or signature strip that is not encoded on the magnetic stripe. Examples of these values are known as Card Validation Code (CVC2), Card Verification Value (CVV2, CVV) and Card Identification Number (CID).

Data Object: A specific coherent structure of electronic data. For example, but not by way of limitation, a JavaScript object, XML document, a datagram, Flash component or multimedia file.

Debit Card: Debit cards have the same form factor and magnetic stripe as credit cards, but are linked to a designated bank account.

Domain: A domain [name] is an identification label that defines a realm of administrative autonomy, authority, or control in the Internet. Domain names are also hostnames that identify Internet Protocol (IP) resources such as web sites. Domain names are formed by the rules and procedures of the Domain Name System (DNS). For example, but not by way of limitation, within the context of a designated computing resource, a “local” domain refers to computing resources of the same IP address or IP address range, and a “remote” domain refers to computing resources of a different IP address or IP address range.

Dynamic Session HTML: A series of computer instructions that describe the real-time presentation of elements within a structured user interface as they relate to a Primary Content and to customizations specific to the active End User, transaction or user session. For example, but not by way of limitation, the HTML and cascading style sheet generated from an online merchant's web server application that is personalized for a specific End User, and provide a template for creating a dynamic facsimile of the then-current aesthetic elements of “Bob's current purchase transaction on Webstore.com”.

EDC Terminal: An EDC terminal—sometimes referred to as Electronic Data Capture terminal—a point-of-sale device that reads information encoded in the bankcard's magnetic stripe, performs authorization functions, stores transaction data, and batches and transmits that data to the acquirer for processing.

Electronic Health Record: An electronic health record (EHR) refers to an individual patient's medical record in digital format.

Electronic Protected Health Information (ePHI): As defined under HIPAA, Electronic Protected Health Information includes any Protected Health Information (PHI) which is created, stored, transmitted or received electronically. Protected Health Information includes any information that identifies an individual and relates to it at least one of the following: 1) the individual's past, present or future physical or mental health. 2) the provision of healthcare to the individual 3) the past, present or future payment for health care

End User: The human who executes applications on a workstation during a Primary Information transaction. For example, but not by way of limitation, a human executing a credit card transaction on an e-commerce website or viewing digital video on a multimedia portal site.

Function: In a computing context, a routine or program (also called procedure, method, process, or routine) is a portion of code within a larger program, which performs a specific task and is relatively independent of the remaining code.

Hosted Payment Page: A computer payment interface provided as a service, often by a remote system and/or third-party. Generally synonymous with “Trusted Proxy Frame.”

iFrame: An inline frame is a computing construct which creates a container “frame” within an electronic document, such as an HTML document, and integrates another electronic document into the frame.

Individually Identifiable Data: under HIPAA, individually identifiable data includes 18 types of identifiers for an individual, the individual's employer or family member. Individually identifiable data also includes information that could be used, either alone or in combination with other information, to identify an individual. The 18 types of identifiers specified by HIPAA include name, address, all elements of dates related to an individual, telephone number, fax number, e-mail address, Social Security number, medical record number, health plan beneficiary member, account number, certificates/license number, any vehicle or other device serial number, device identifiers or serial numbers, web URL, Internet protocol (IP) address number, finger or voice prints, photographic images and any other characteristic that could uniquely identify the individual. Generally synonymous with “personal identifying information.”

Local Domain: see Domain. For example, but not by way of limitation, within the context of a designated computing resource, a local domain refers to computing resources of the same IP address or IP address range. The opposite of a remote domain.

Network Interface: A computing element that mediates electronic communication between computers or computer elements. For example, but not by way of limitation, a physical PCI network interface card, an IP NAT router or a mobile phone GSM radio.

Network: an interconnected system that transfers electronic data between computers or components within a computer. For example, but not by way of limitation, the Internet, a TCP/IP network connection, an Ethernet cable, a USB connection, and Extended ISA.

Payment Gateway: A Payment Gateway is service provided by an e-commerce application Publisher that authorizes all payments for electronic merchants, internet retailers, those companies that use both physical retail spaces and online sales, or traditional brick and mortar retail centers.

Payment Processor: A Payment Processor is a company that routes credit card transactions from merchant locations to credit card issuers for complete authorization and eventual settlement.

PCI Data Security Standard (PCI DSS): PCI DSS is a multifaceted security standard intended to protect Cardholder Data from criminal access. PCI DSS includes requirements for security management policies and procedures. PCI DSS is administered by the PCI Security Standards Council, a body originally founded by various credit card providers.

Personal Identification Number: A Personal Identification Number—or PIN—is a numeric password shared between a user and a system that can be used to authenticate the user to the system.

Primary Function: See Primary Predetermined Computing Function.

Primary Information: A body of information in digital form. For example, but not by way of limitation, credit card numbers, Social Security numbers, protected health information, copyright-protected digital works and logon credentials whose confidentiality, legality, commercial value or other attributes could be compromised by unauthorized disclosure, theft or tampering.

Primary Predetermined Computing Function: A computer process of a Publisher that provides a function for an End User to interact with. For example, but not by way of limitation, an e-commerce shopping cart function, and electronic banking portal, a health record management system or an on-demand video streaming website application.

Process: In a computing context, a routine or program (also called procedure, method, function, or routine) is a portion of code within a larger program, which performs a specific task and is relatively independent of the remaining code.

Protected Health Information: Under HIPAA, includes any information that identifies an individual and relates to it at least one of the following: 1) the individual's past, present or future physical or mental health. 2) the provision of healthcare to the individual 3) the past, present or future payment for health care

Publisher: An agent that generates and provides access to the Primary Content. For example, but not by way of limitation, an e-commerce merchant, a healthcare information portal, a tax payment processor and an on-demand multimedia access portal. One type of Publisher is an authorized acceptor of a credit or debit card as payment for goods and services.

Remote Domain: see Domain. For example, but not by way of limitation, within the context of a designated computing resource, a remote domain refers to computing resources of a different IP address or IP address range. The opposite of a local domain.

Remote Domain Frame: (also see Trusted Proxy Frame) A trusted function or interface, typically associated with an iFrame. For example, but not by way of limitation, an HTML iFrame object. According to another aspect of the system, also known as a trusted proxy frame.

Secondary Content: A specific predetermined computer process that embodies a user interface and designated functions applied to a Primary Information transaction. For example, but not by way of limitation, an HTML document.

Secondary Function: See Secondary Predetermined Computing Function

Secondary Predetermined Computing Function: A specific computer process that embodies designated functions applied to a Primary Information transaction and generates the Secondary Content. For example, but not by way of limitation, a Secondary Predetermined Computing Function is a payment processing algorithm, a database or application server and Secondary Content is a payment card approval document, an electronic health record, or a digital work.

Secondary Server: A computer server configured to provide the Secondary Content that may comply with policies for handling Primary Information. For example, but not by way of limitation, a secure server, an application server deployed within a trusted computer or PCI DSS compliant data center.

Secure Channel: A method of transferring electronic data that is resistant to interception and tampering. For example, but not by way of limitation, a communication employing an HTTPS or SSL protocol.

Secure Server: A trusted computer or computing function. For example, but not by way of limitation, a web server that supports any of the major security protocols, such as SSL, that encrypt and decrypt messages to protect them against third-party tampering or fraudulent use.

SSL Certificate: SSL (Secure Sockets Layer) certificates are files, regularly installed on safe online servers, which recognize a specific website.

The Health Insurance Portability and Accountability Act (HIPAA): HIPAA is the United States Health Insurance Portability and Accountability Act of 1996.

Third Party Processor: An agent that provides the Second Predetermined Computing Function. For example, but not by way of limitation, a payment processor, a bank, a healthcare information provider or a multimedia content distribution center. Generally synonymous with Third Party Data Processor.

Token: A digital element incorporating identification and authorization credentials that acts as a proxy representative for a user or data set without revealing the actual identity, content or attributes of the user or data. For example, but not by way of limitation, an XML message or software key used for authentication and authorization purposes during a Primary Information transaction.

Transaction: an agreement, communication or movement carried out between separate entities or objects, often involving the exchange of items of value. For example, but not by way of limitation, an exchange of electronic data between an end user and a Publisher to complete an online purchase or information submission.

Trigger Event: an act or event that meets predetermined conditions for initiating a process. For example, but not by way of limitation, an error condition in a computer application or a request for application services.

Trusted Proxy Frame: A trusted function or interface, typically associated with an iFrame. For example, but not by way of limitation, an HTML iFrame object. According to another aspect of the system, also known as a remote domain frame.

Unrestricted Information: Electronic data which can be publicly disclosed without compromising its sensitivity, legality, commercial value or other attributes; the opposite of Primary Information. For example, but not by way of limitation, the shipping address provided in an e-commerce transaction, publicly distributed medical information from a healthcare provider, a public trailer for a copyright-protected digital work or a digital work in the public domain.

Web Server: A computing function that serves files and applications to users via the Internet. For example, but not by way of limitation, a physical computer running the Apache Software Foundation's Apache Web Server, configured to house and enable Web-based content and applications.

### OVERVIEW

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

A system constructed in accordance with aspects of the invention(s) provides a method to enforce policies for the collection and handling of Sensitive Information within a non-policy-compliant Publisher environment, while maintaining the aesthetic and functional integrity of the non-compliant Publisher application and end user experience.

According to another aspect, a system constructed as described herein provides a method to mediate policy-compliant transactions between a Publisher and a plurality of Third-Party Processors (“Third-Party Processor”).

According to another aspect, a system constructed as described herein provides a real-time method to transparently segregate Sensitive Information collection and handling from distrusted Publisher application processes.

In accordance with a particular aspect, a system as described herein provides a method to create a policy-compliant software device (a “Trusted Proxy Frame”) within a trusted computing environment (“Trusted Server”). The Trusted Proxy Frame construct embodies multiple nested layers. Exemplary nested layers include a display layer, a form layer, and a transport layer. Consistent with these aspect, such a system provides a real-time method for a Publisher to signal the Trusted Server and retrieve the Trusted Proxy Frame device via an electronic data communication conduit. This signal is automatically triggered in response to a predefined Publisher application event. An exemplary trigger event is the selection of an “order now” command by a human customer at the Publisher website (“End User”).

The system provides a method to bi-directionally validate the source of the Trusted Proxy Frame and the authenticity of the Trusted Proxy Frame component within the Publisher Application and to periodically revalidate endpoint authenticity during a Sensitive Information exchange process. Exemplary authentication methods include encrypted key exchange protocols, such as public/private key encryption mechanisms. An exemplary Sensitive Information exchange process is an e-commerce transaction which exchanges credit card information via an electronic network conduit.

The system uses methods deployed within the Publisher Application that retrieve and insert the Trusted Proxy Frame during a sensitive data exchange process. The Trusted Proxy Frame is inserted into a designated container within the Publisher Application interface. An exemplary Publisher Application is a Web server that embodies e-commerce shopping cart software. An exemplary Trusted Proxy Frame is an HTML document that embodies data fields, images and related information. An exemplary designated container is an I-Frame HTML construct.

The system dynamically integrates the Trusted Proxy Frame into a distrusted Publisher Application. The sum of this integration yields policy-compliant handling of Sensitive Information within the distrusted Publisher Application. It also maintains the aesthetic and functional consistency of the Publisher Application.

The system provides a method to create an Authentication Key field within the Trusted Proxy Frame.

The system provides a method to create an Authentication Key within the Trusted Server and to populate the Authentication Key field of the Trusted Proxy Frame with this key during the Transaction Initiation Process.

The system authenticates the source and identity of the Trusted Server and Trusted Proxy Frame communication endpoints during the Transaction Initiation Process. The system periodically revalidates endpoint authenticity until the transaction process has been completed. An exemplary periodic endpoint authentication process verifies appropriate Authentication Key field values of the Trusted Server and Trusted Proxy Frame every 100 milliseconds.

The system provides a method to terminate a transaction and initiate alarms in the event of an authentication failure of or between the Trusted Proxy Frame and the Trusted Server.

The system provides a method to capture End User Sensitive Information (“Third-Party Data Processing Information”) via the Trusted Proxy Frame interface. Exemplary Third-Party Data Processing Information includes credit card numbers, card expiration dates and Card Validation Codes (CVC2).

The system provides a method to inspect Publisher Application and Trusted Proxy Frame elements that request Trusted Server services to verify these elements (“Calling Object”) have not been subject to unauthorized tampering or modification. When a Calling Object is modified, Publisher Application elements notify the Trusted Server. The Trusted Server then queries point-in-time attributes of the Calling Object and applies algorithms of the system to create a unique digital identifier (“Digital Fingerprint”) of the Calling Object. On a randomly enforced schedule, the Trusted Server re-queries the Calling Object and recalculates the Digital Fingerprint based on the then-current attributes. The recalculated Digital Fingerprint is compared to Digital Fingerprints previously associated with the Calling Object. If the two “digital fingerprints” do not match, the Trusted Server will alert the Publisher to the unexpected modifications of Calling Object attributes.

The system provides a method to present the Third-Party Data Processing Information and transaction request to a Third-Party Processor for purposes of transactional review.

The system provides a method to receive a transaction inquiry response from the Third-Party Processor and communicate the Third-Party Processor response to the End User and the Publisher.

The system provides a static reference point deployed within the domain of the Publisher application that complies with container-specific security policy. This static reference point provides a foundation for programmatic response methods that interoperate with Publisher Application functionality. An exemplary configuration includes an HTML page with a JavaScript functions that interoperate with the Trusted Server and The Publisher Application. Exemplary JavaScript functions control data entry, error handling and return control to the Publisher Application when transactions are complete.

The system provides a method to capture End User Sensitive Information (“Third-Party Data Processing Information”) via the Trusted Proxy Frame interface. Exemplary Third-Party Data Processing Information includes credit card numbers, card expiration dates and Card Validation Codes (CVC2).

According to another aspect of the system, the system generates a trusted proxy frame interface that enables a distrusted Primary Function to mediate trusted Primary Information transactions between a plurality of Internet domains and endpoints, without compromising Primary Function operational characteristics in the associated user transaction session.

Elements of the system may be embedded as a function within a distrusted Primary Function. For example, but not by way of limitation, software code of the system may be implemented as a JavaScript function and embedded as an iFrame object in an HTML-based application interface.

The system includes a trusted computing environment (“Secure Server”). For example, but not by way of limitation, a trusted computing environment may be a server configured to comply with a designated security protocol such as PCI DSS.

The embedded element of the system is able to receive a trigger event signal from a Primary Function, the event signal including instructions, transaction parameters and data. The event data is automatically triggered in response to a predefined Publisher application load event. An exemplary trigger event is the selection of an “order now” command by a human customer at the Publisher website (“End User”).

In response to the event signal, the system creates, on demand, a trusted user interface software device (“Trusted Proxy Frame”) in the Secure Server. For example, but not by way of limitation, a trusted proxy frame is an HTML iFrame object.

The system provides a method to create a hidden Authentication Key field within the Trusted Proxy Frame.

The system provides a method to create a hidden Authentication Key within the Secure Server and to populate the Authentication Key field of the Trusted Proxy Frame with this key during the Transaction Initiation Process.

The system has the ability to authenticate the Secure Server, using an authentication key, to ensure it is the actual source of the Trusted Proxy Frame. For example, but not by way of limitation, authentication methods include encrypted key exchange protocols, such as public/private key encryption mechanisms.

The system includes a method to allow or deny transaction requests based on one or more predetermined transaction parameter tests. For example, but not by way of limitation, transaction parameter tests may include requirements regarding transaction endpoint domains, network traffic rules and user session attributes.

The system has the ability to periodically re-authenticate the actual source of the Trusted Proxy Frame on a predetermined schedule. For example, but not by way of limitation, re-authentication methods include initialization of an encrypted key exchange protocol, such as a public/private key encryption mechanism, at 10 second intervals.

The system has the ability to display the Trusted Proxy Frame within a designated container of the Primary Function user interface. For example, but not by way of limitation, a designated container may be an iFrame HTML construct.

The system has the ability to maintain logical segregation between the source domain of the Trusted Proxy Frame, the domain of the Primary Function and the source domain of the Primary Information. For example, but not by way of limitation, domain segregation may be enforced using browser controls the present cross-site scripting functions.

The system provides a static reference point deployed within the domain of the Publisher application that complies with container-specific security policy. This static reference point provides a foundation for programmatic response methods that interoperate with Publisher application functionality. An exemplary configuration includes an HTML page with a JavaScript functions that interoperate with the Secure Server and the Publisher application. Exemplary JavaScript functions control data entry, error handling and return control to the Publisher application when transactions are complete.

The system has the ability to present a data transaction object to an End User, via the embedded Trusted Proxy Frame. For example, but not by way of limitation, a data transaction object comprising a content collection form.

Using the object within the Trusted Proxy Frame, the system is able to collect Primary Information from the End User.

Elements of the system have the ability to interact and exchange data with a Secondary Predetermined Computing Function (Secondary Function), the data consisting of Primary Information, an authentication key and related transaction content.

The system has the ability to receive secondary data from the Secondary Function and to respond using predetermined algorithms. For example, but not by way of limitation, the secondary data comprising a transaction approval signal that is relayed by the system to a Publisher web application.

The system has the ability to transparently vary the active source and method of communication so that trusted components may be aesthetically and functionally integrated with distrusted components while maintaining logical segregation.

The system has ability to return session control to the Primary Function when the Primary Information transaction is complete.

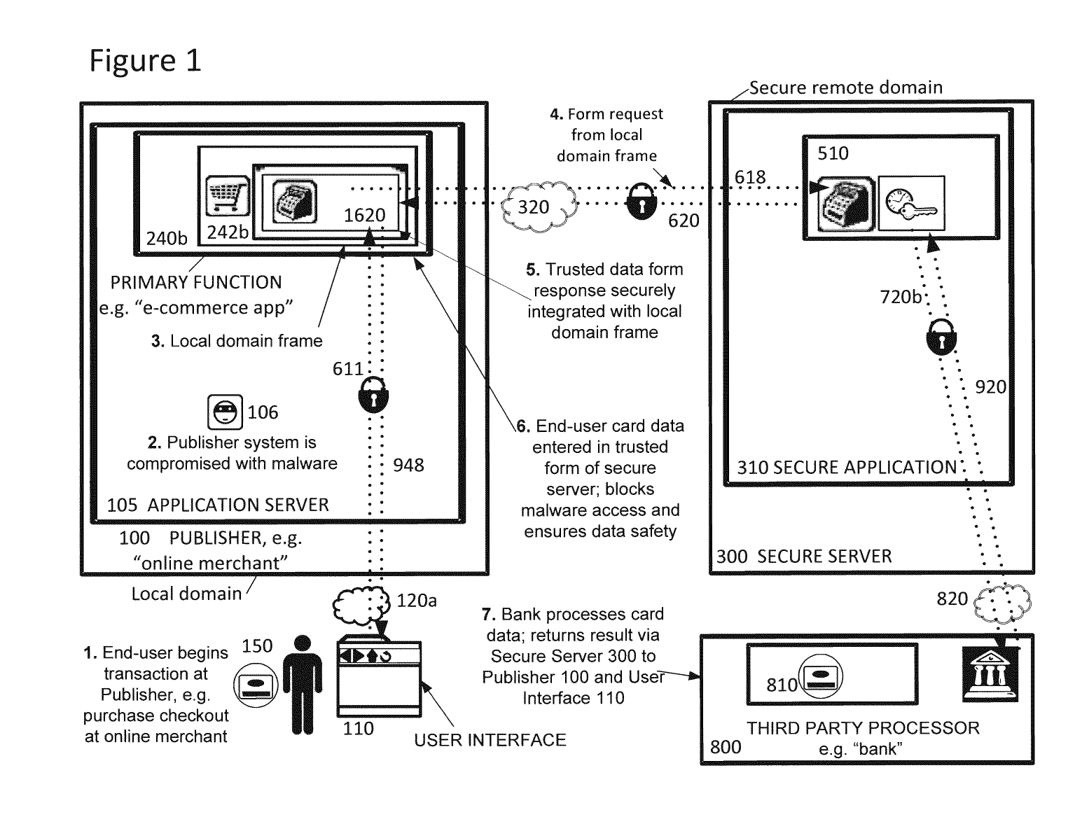

Turning now to the figures, in which like numerals indicate like elements or components between the several drawing figures, FIG. 1 is a system diagram illustrating a preferred embodiment of the system to mediate a trusted exchange of primary information in a computing environment. For example, but not by way of limitation, the safe exchange of credit card data in a transaction involving a human customer, an distrusted online merchant, a bank and a trusted server of the system. An alternate exemplary configuration a patient “End User”, protected electronic health records, a distrusted field healthcare clinic, an insurance company and a trusted server of the system.

FIG. 1 includes four element groups arrayed in clockwise order, with one group in each corner. In the bottom left corner, the first group of elements includes Primary Information 150. Primary Information 150 is an assembly of data elements subject to handling under designated policy standards. For example, but not by way of limitation, credit card numbers, card expiration dates and electronic health records.

Immediately adjacent to Primary Information 150 is User Interface 110. For example, but not by way of limitation, User Interface 110 is a human user interface, defined in software, to access a computing function. In the top left corner, a second group includes Publisher 100 (“Online Merchant”). For example, but not by way of limitation, Publisher 100 is an online merchant. Publisher 100 embodies Application Server 105. Application Server 105 is a computing construct. For example, but not by way of limitation, a software system such as the Apache Software Foundation's Apache Web Server configured to house and enable web-based content and applications.

For example, but not by way of limitation, Application Server 105 a Web server system. Application Server 105 embodies Primary Function 240b, which in turn contains Local Domain Frame 242b and Trusted Proxy Frame 1620. Primary Function 240a is a computing construct embodied within Application Server 105 that interfaces with users, objects and data. For example, but not by way of limitation, a web-enabled software system that aggregates an end user's online product selections and presents a “shopping cart” interface with an item list, cost, shipping and related information.

Local Domain Frame 242b is a container “frame” created within an electronic document that integrates another electronic document into the frame. For example, but not by way of limitation, an HTML iFrame webpage construct.

Application server 105 also embodies Computer Malware 106. For example, but not by way of limitation, Computer Malware 106 is an unauthorized software program covertly installed by criminal “hacker” on an e-commerce Web server by a criminal for purposes of stealing data card information.

The element group in the top right corner of FIG. 1 is Secure Server 300, a computing construct of the system configured to be in compliance with designated Primary Information handling policies. For example, but not by way of limitation, Secure Server 300 is a computer server configured to comply with PCI DSS information security standards.

Secure Server 300 embodies secure application 310 and process 510. For example, but not by way of limitation, secure application 310 is a Web server and Trusted Frame Process 510 is a software defined algorithm module.

The element group in the bottom right corner of FIG. 1 includes Third-Party Data Processor 800 (“Card Processor”), a networked computing construct. For example, but not by way of limitation, a bank that processes payment card transactions. Third-party data processor 800 embodies Function 810. For example, but not by way of limitation, a credit card processing algorithm.

FIG. 1 also includes WAN120a, WAN 320 and WAN 820. These elements are communications conduit that carry electronic data communications between and within computing resources. For example, but not by way of limitation, the Internet.

FIG. 1 also includes dashed lines 611, 618, 620, 720 B, 920 and 948. These are illustrative elements.

The exemplary FIG. 1 includes a 7-step process, the initial processes of transaction involving Primary Information 150 generally flowing in a clockwise cycle, e.g. from User Interface 110 to Publisher 100, from Publisher 100 to Secure Server 300, from Secure Server 300 to Third-Party Data Processor 800. Following completion of functions of Third-Party Data Processor 800, subsequent processes of the primary information track transaction generally flow in a counterclockwise order, e.g. from Third-Party Data Processor 800 to Secure Server 300, to Publisher 100 and User Interface 110.

Step 1 and dashed line 611 depict a human end user using User Interface 110 to begin a purchase checkout at online merchant 100.

Step 2 depicts Computer Malware 106, a malicious software device covertly installed on the computer systems of online merchant 100 for purposes of stealing credit card data (Primary Information 150) as it is entered during a purchase transaction.

Step 3 depicts an E-commerce Local Domain Frame 242b of online merchant 100.

Step 4 and dashed line 618 depict a request by the E-commerce shopping cart of online merchant for a trusted data form from Secure Server 300.

Step 5 and dashed line 620 depict the trusted form response of Secure Server 300, which is integrated within the E-commerce shopping cart of online merchant 100.

Step 6 depicts the entry of Primary Information 150 into the trusted form of e-commerce Local Domain Frame 242b, which securely bypasses Computer Malware 106.

Step 7. and dashed line 720b depict the processing of card data by third party data processor 800 (“card processor”) and as illustrated by dashed lines 920 and 948, the return of a response (for example, but not by way of limitation, a confirmation or error message) to online merchant 100 and User Interface 110 via Secure Server 300.

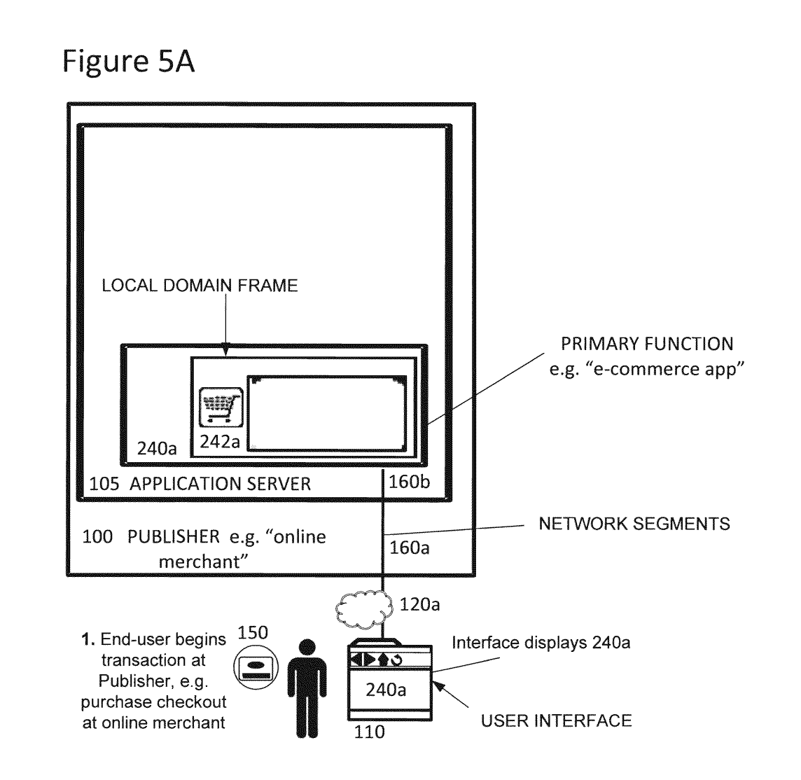

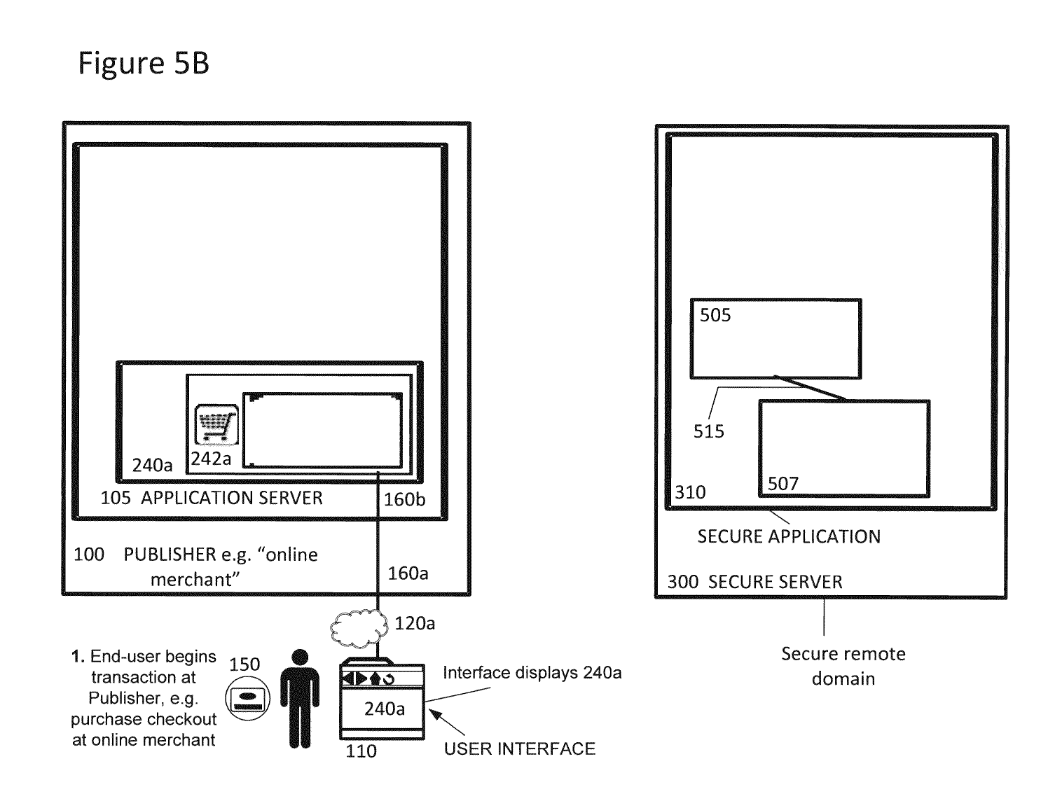

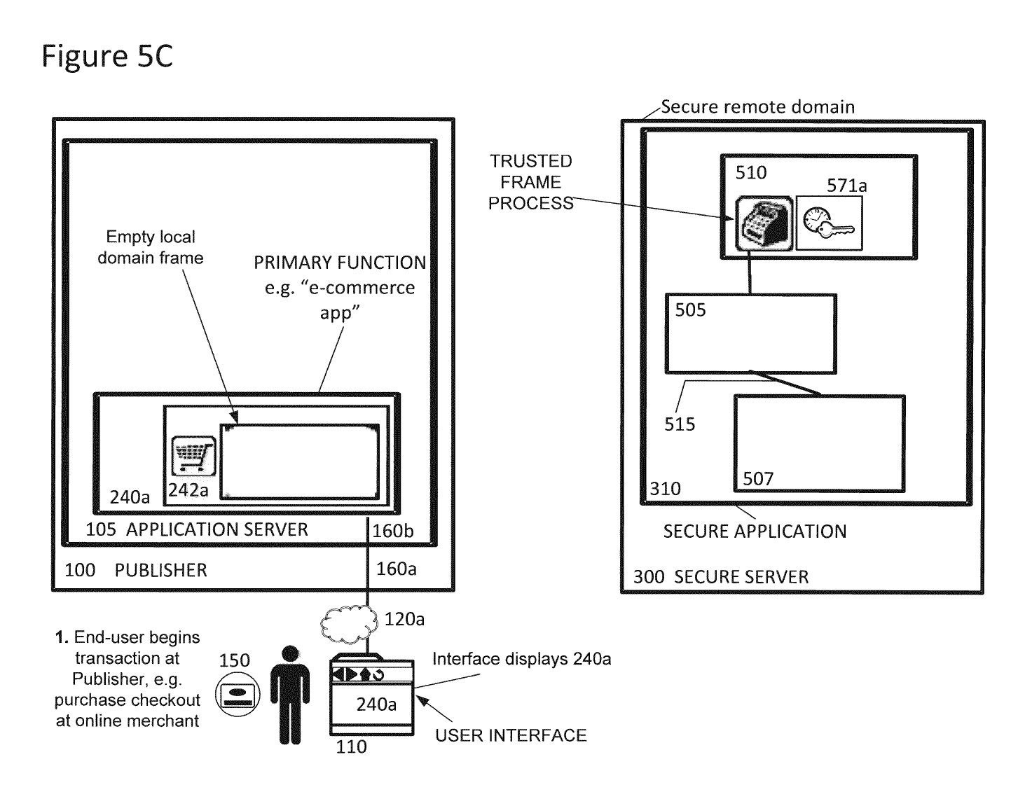

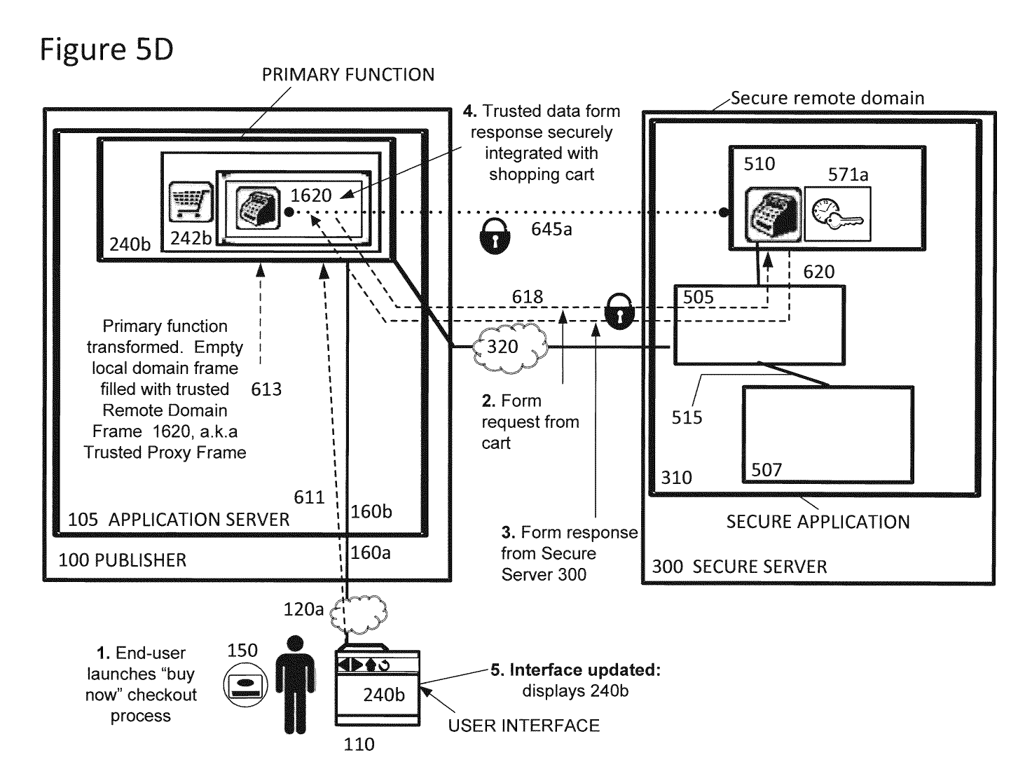

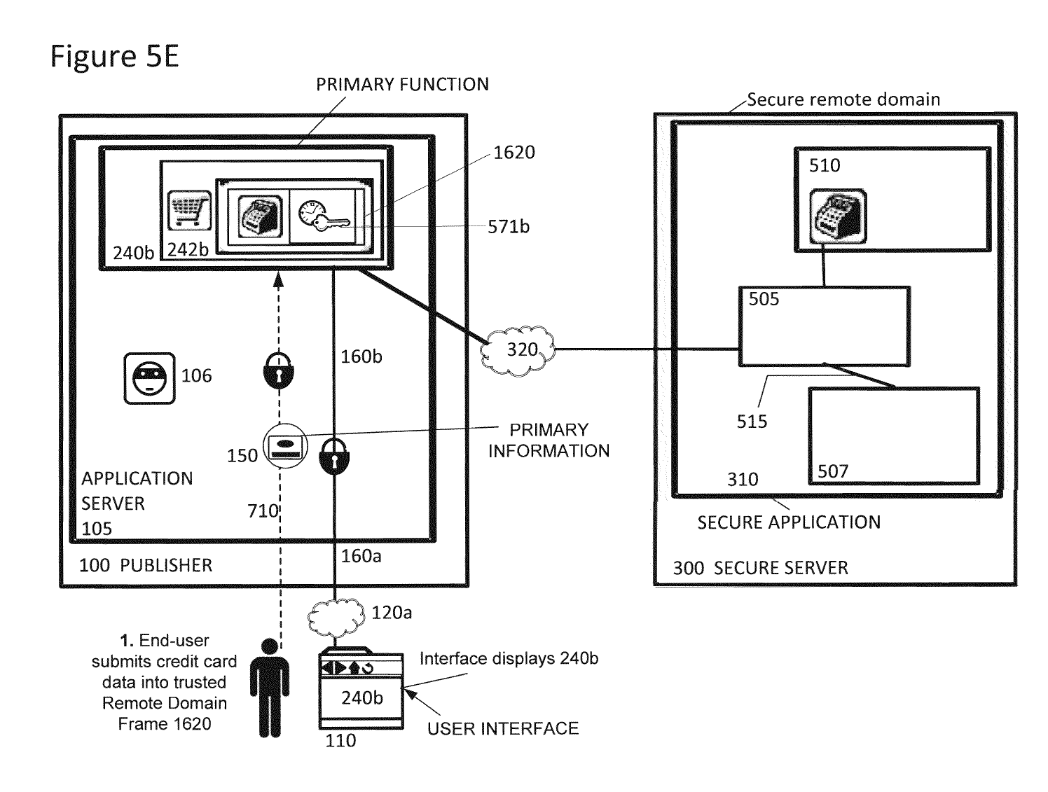

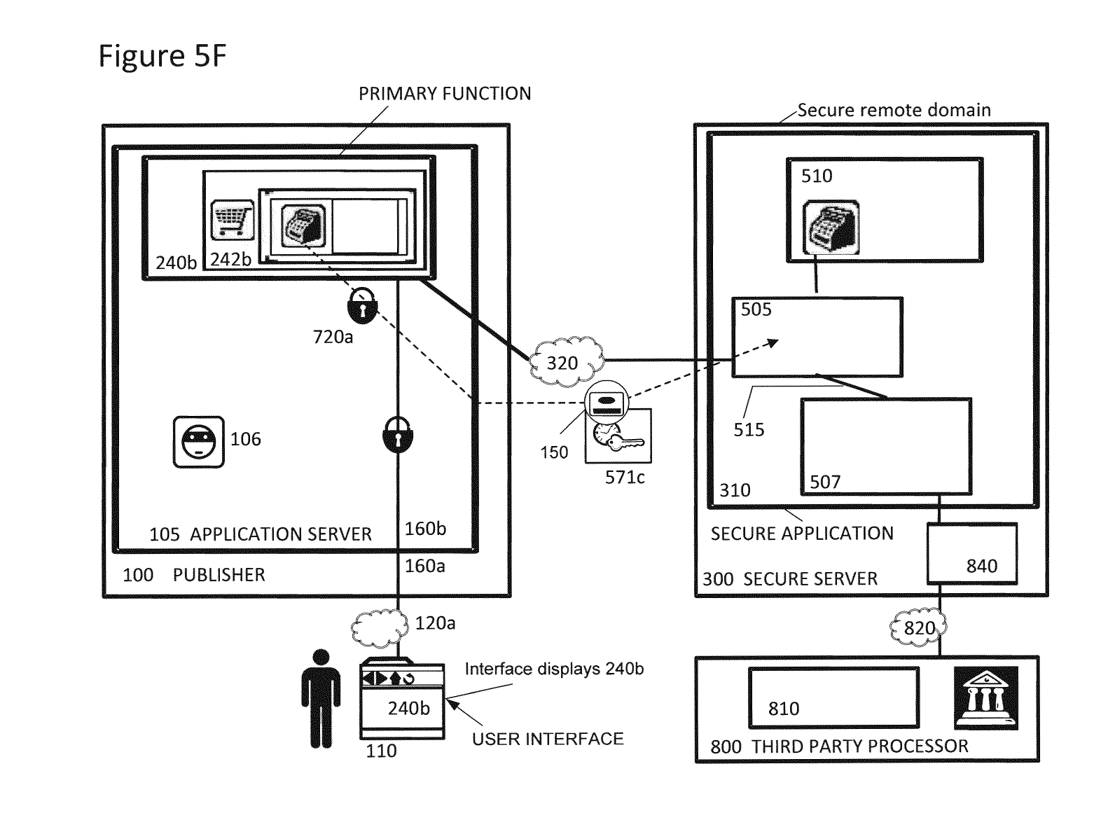

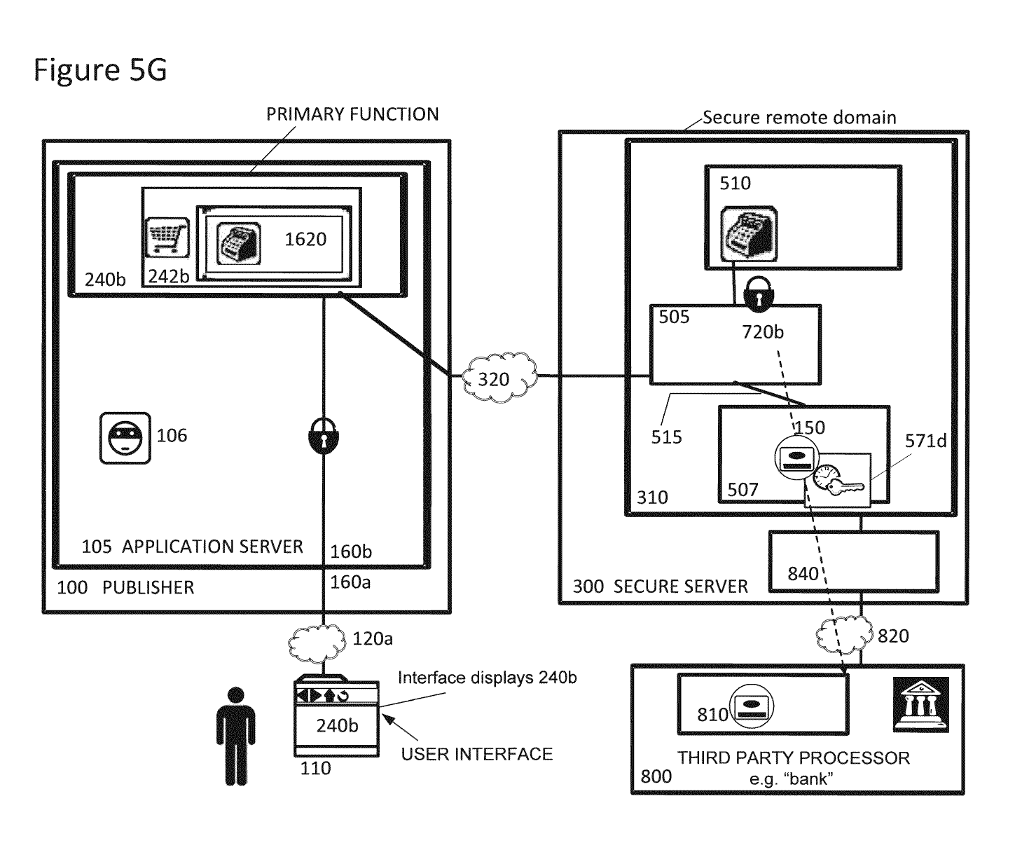

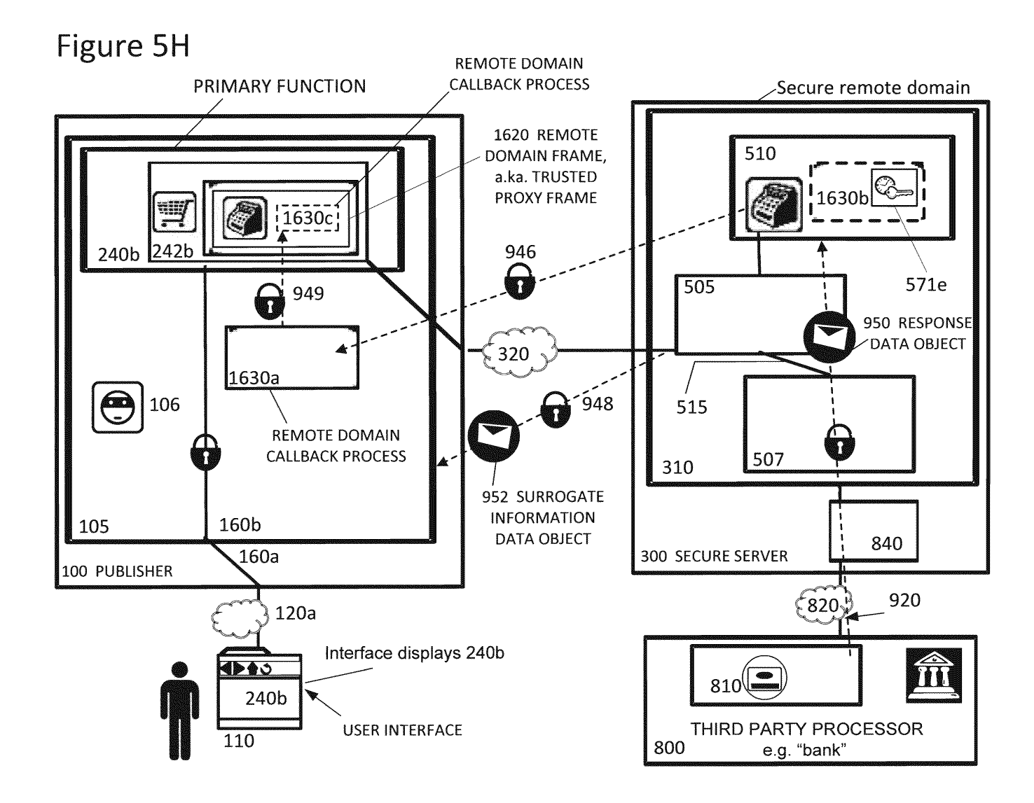

Steps 1-7 are depicted in greater detail in FIGS. 5A-5H. The embodiments of the system depicted in this and other figures prevent unauthorized and distrusted agents from accessing or interacting with Primary Information 150. For example, but not by way of limitation, from intercept or observation by Computer Malware 106.

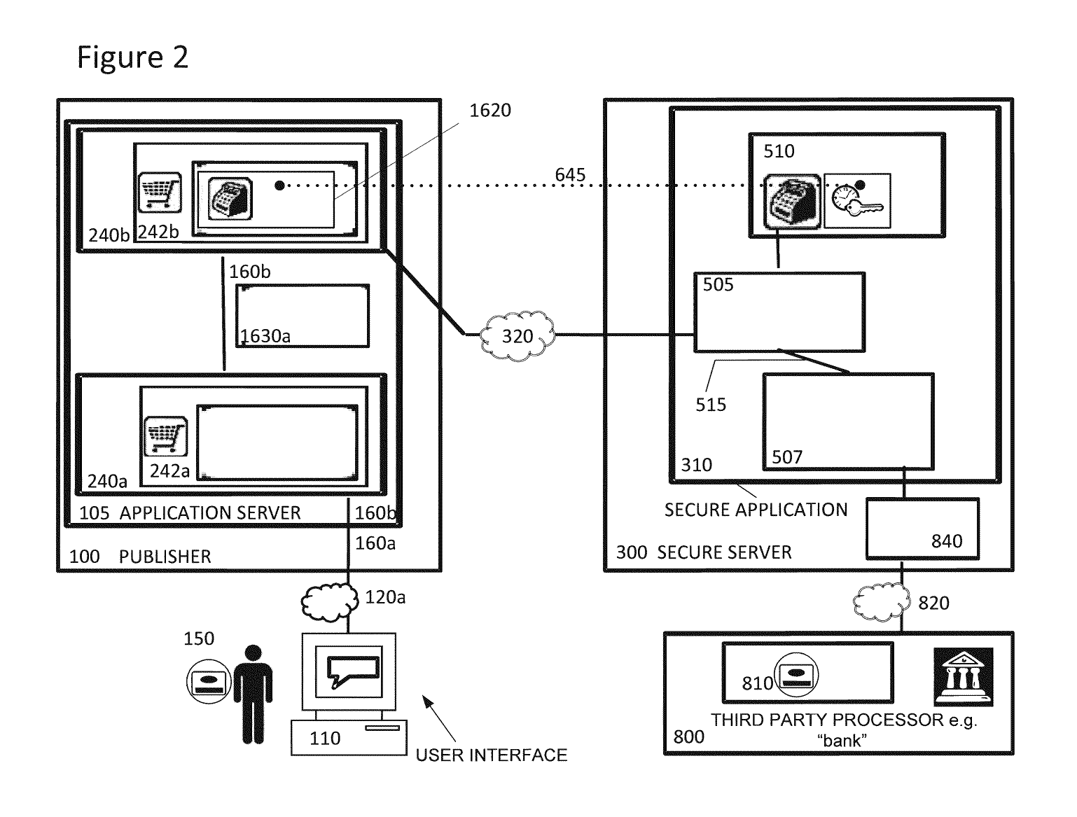

FIG. 2 is a system diagram of a preferred embodiment of the system to enforce Primary Information handling policies in a computing environment. An exemplary information security policy standard is the PCI DSS protocol. FIG. 2 incorporates the elements of FIG. 1 and adds:

Network Segments 160a, 106b and 515. For example, but not by way of limitation, a LAN segment.

Primary Function 240a, which embodies Local Domain Frame 242a. For example, but not by way of limitation, Primary Function 240a is a webpage interface for an e-commerce shopping site and Local Domain Frame 242b is a HTML-defined construct.

Remote Domain Callback Process 1630a. For example, but not by way of limitation, an HTML iFrame object.

Gateway 505 and 840. For example, but not by way of limitation, a network router.

Transaction process 507. Transaction Process 507 is a computing construct that embodies algorithms of the system. For example, but not by way of limitation, algorithms for signaling, information processing or traffic routing.

Dashed line 645 is an illustrative element.

The embodiments of the system depicted in this and other figures prevent unauthorized and distrusted agents from accessing or interacting with Primary Information 150. For example, but not by way of limitation, from intercept or observation by Computer Malware 106.

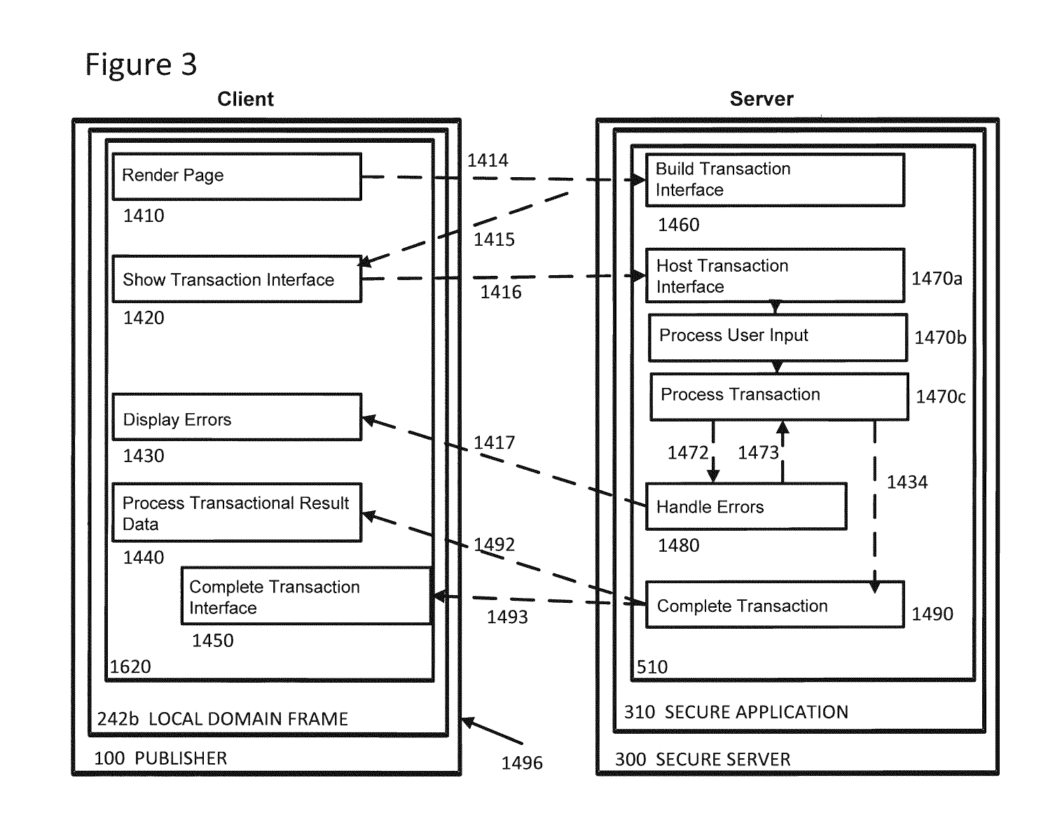

FIG. 3 is a logical flowchart diagram depicting key processes in a trusted proxy transaction. FIG. 3 depicts system procedures to process Primary Information transactions and present results. FIG. 3 includes Publisher 100 and Secure Server 300 of FIG. 1. FIG. 3 adds Publisher Application 640, Trusted Proxy Frame 1620, Secure Server Application 310 and Trusted Frame Process 510.

FIG. 3 also includes Render Page Process 1410, Show Transaction Interface Process 1420, Display Error Interface 1430, Process Transactional Result 1440, Complete Transaction Interface 1450, Build Transaction Interface 1460, Host Transaction Process 1470a, Process User Input 1470b, Process Transaction 1470c, Handle Errors Process 1480 and Complete Transaction Process 1490.

FIG. 3 also includes dashed lines 1414, 1415, 1416, 1417, 1492, 1493 and 1496 that illustrate connections and/or information passed between illustrated elements or components.

Publisher Application 640 is a computing construct that embodies a user interface. An exemplary Publisher Application 640 Is an HTML document.

Trusted Proxy Frame 1620 is a computing construct of the system. An exemplary Trusted Proxy Frame 1620 is a JavaScript object.

Secure Server Application 310 is a computing construct of the system. An exemplary Secure Server Application 310 is an Apache Web server.

Trusted Frame Process 510 is a computing construct of the system.

Build Transaction Interface 1460, Host Transaction Processes 1470a, Process User Input 1470b, Process Transaction 1470c, Handle Errors Process 1480 and Complete Transaction Process 1490 are computing constructs of the system embodied within Trusted Frame Process 510.

Render Page Process 1410, Show Transaction Interface Process 1420, Display Error Interface 1430 Process Transactional Result 1440 and Transaction Completion Interface 1450 are computing constructs of the system embodied within Trusted Proxy Frame 1620. Examples include HTML documents.

As depicted by dashed line 1496 In FIG. 3, a Primary Information transaction request is received by Publisher Application 640.

Publisher Application 640 then requests Primary Information processing services from the embodied Trusted Proxy Frame 1620.

Trusted Proxy Frame 1620 initiates Page Rendering Process 1410. As depicted by dashed line 1414, Page Rendering Process 1410 communicates a request to Build Transaction Interface 1460.

As depicted by dashed line 1415, Build Transaction Interface 1460 creates and sends an interface template Data Object which is displayed by Show Transaction Interface 1420.

Primary Information is entered into Show Transaction Interface 1420. As depicted by dashed line 1416, Primary Information is forwarded to Host Transaction Interface 1470a. The input information and transaction are processed in Process User Input 1470b and Process Transaction 1470c.

As depicted by dashed line 1472, errors occurring in Process Transaction 1470c are forwarded to Handle Errors 1480. As depicted by dashed line 1417, these errors are returned to Publisher Application 640 and presented within Display Errors 1430.

As depicted by dashed line 1473, processed errors are returned to Process Transaction 1470c and then as illustrated by dashed line 1434, the process advances to Complete Transaction 1490.

As illustrated by dashed lines 1492 in 1493, completed transaction results are forwarded to Process Transactional Result Data 1440 and presented within Complete Transaction Interface 1450.

The embodiments of the system depicted in this and other figures prevent unauthorized and distrusted agents from accessing or interacting with Primary Information 150. For example, but not by way of limitation, from criminal intercept or observation.

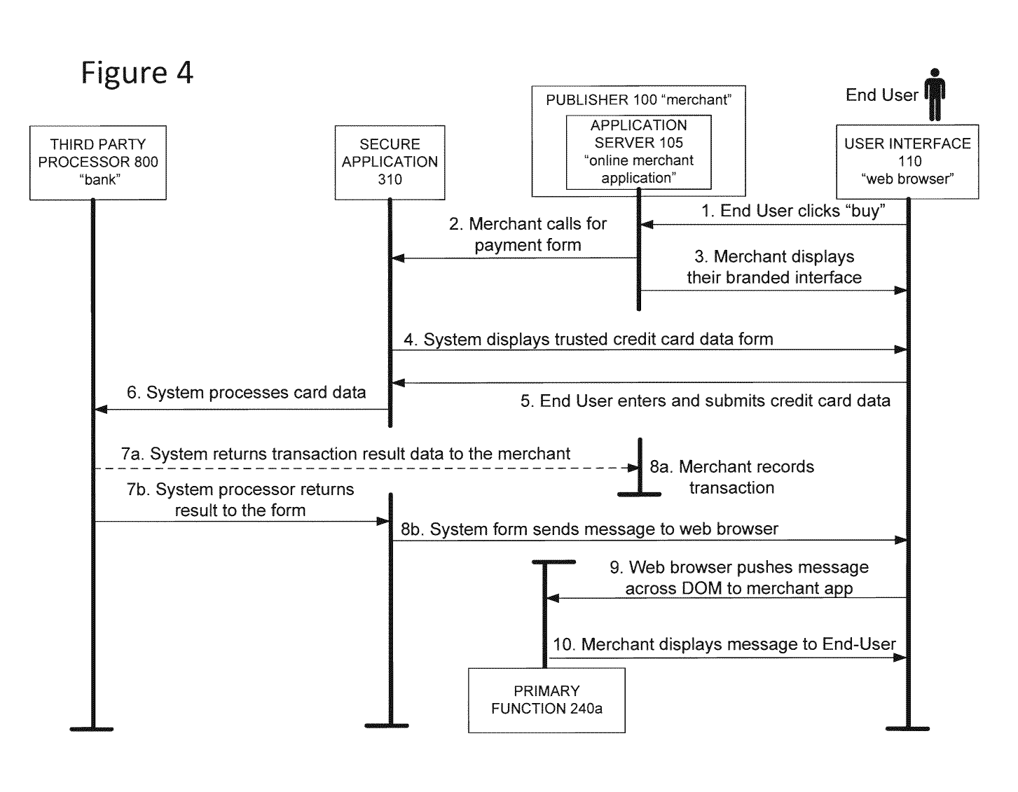

FIG. 4 is a logical flowchart diagram depicting key processes in an exemplary trusted proxy transaction. It will be understood that aspects of the invention are implemented as computer program processes and/or modules and/or programs that execute on general purpose computers operated by a publisher (such as a merchant or healthcare provider or similar entity), a secure server, a third party data processor, and an end user possessing the sensitive information. FIG. 4 illustrates an example of a suitable networked computing system environment on which embodiments may be implemented. The networked computing system environment is only one example of a suitable computing environment and is not intended to suggest any limitation as to the scope of use or functionality of the claimed subject matter. Neither should the computing environment be interpreted as having any dependency or requirement relating to any one or combination of components illustrated in the exemplary operating environment.

Although aspects of the invention(s) are shown as computer-implemented processes, occurring in a particular order or sequence, and on occasion with seemingly sequential numbering or identification in the drawings, it should be understood that in many instances there is no required ordering or sequencing of certain processes or steps or operations, except when certain processes or steps or operations require the results of a temporally-earlier process or step or operation in order for its function to occur. Many computer operations are asynchronous in nature, many operate in endless loops awaiting a particular input or stimulus, and many operate in response to receiving a message or being passed a parameter or provided with an input or stimulus. Thus, no ordering or sequencing should be imposed on the claimed inventions except where necessary and required due to the need for a prior temporal operation. Generally, therefore, the invention(s) and their aspects should be interpreted as not limited to a particular ordering or sequence.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like. Embodiments may be described in the general context of computer-executable instructions, such as program modules, being executed by a computer. Generally, program modules include routines, programs, objects, components, data structures, etc. that perform particular tasks or implement particular abstract data types. Embodiments as described herein are designed to be practiced in distributed computing environments where tasks are performed by remote processing devices that are linked through a communications network. In a distributed computing environment, program modules are located in both local and remote computer storage media including memory storage devices.

An exemplary system for implementing some embodiments includes a general-purpose computing device in the form of one or more computers or servers. Components of such computers or servers may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computers and servers typically include and utilize a variety of computer readable media. Computer readable media can be any available media that can be accessed by the computer or server and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory for a computer or server includes computer storage media in the form of volatile and/or nonvolatile memory such as read only memory (ROM) and random access memory (RAM). A basic input/output system (BIOS), containing the basic routines that help to transfer information between elements within computer or server, such as during start-up, is typically stored in ROM. RAM typically contains data and/or program modules that are immediately accessible to and/or presently being operated on by a processing unit in the computer or server. By way of example, and not limitation, each computers or server in FIG. 4 includes an operating system, application programs, other program modules, and program data.

The computer or server may also include other removable/non-removable volatile/nonvolatile computer storage media. By way of example only, each computer or server may include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. A hard disk drive is typically connected to the system bus through a non-removable memory interface, and any magnetic disk drive and/or optical disk drive are typically connected to the system bus by a removable memory interface.

The drives and their associated computer storage media discussed above provide storage of computer readable instructions, data structures, program modules and other data for the computer or server. As is known to those skilled in the art, a hard disk drive typically stores an operating system, application programs, other program modules, and program data.

A user such as an end user may enter commands and information into his or her computer through input devices such as a keyboard, a microphone, and/or a pointing device such as a mouse, trackball, or touch pad (not shown). Other input devices may include a joystick, game pad, satellite dish, scanner, or the like. These and other input devices are often connected to the processing unit of the computer through a user input interface that is coupled to the system bus, but may be connected by other interface and bus structures, such as a parallel port, game port or a universal serial bus (USB). A monitor or other type of display device (not shown) is also connected to the system bus via an interface, such as a video interface. In addition to the monitor, computers may also include other peripheral output devices such as speakers and printer, which may be connected through an output peripheral interface.

The computers operated by the secure server and third party processor are typically operated in a networked environment using logical connections to one or more remote computers. Any remote computer or server may be a personal computer, a hand-held device, a server, a router, a network PC, a peer device or other common network node, and typically includes many or all of the elements described above relative to the computer. The logical connections depicted in FIG. 4 include a local area network (LAN) and a wide area network (WAN), but may also include other networks. Such networking environments are commonplace in offices, enterprise-wide computer networks, intranets and the Internet.

When used in a LAN networking environment, a computer or server is connected to the LAN through a network interface or adapter. When used in a WAN networking environment, the computer typically includes a modem or other means for establishing communications over the WAN, such as the Internet. The modem, which may be internal or external, may be connected to the system bus via the user input interface, or other appropriate mechanism. In a networked environment, program modules depicted relative to the computer, or portions thereof, may be stored in the remote memory storage device. It will be appreciated that the network connections shown are exemplary and other means of establishing a communications link between the computers may be used.

FIG. 4 includes User Interface 110, Application Server 105, Secure Application 310 and Third-Party Processor 800 of FIG. 1. FIG. 4 depicts a 10 step process flow of an exemplary e-commerce credit card transaction involving an End-User, “card data” Primary Information, a “web browser” User Interface, a distrusted “merchant” Publisher, a distrusted “online merchant application” Application Server, a Secure Server, a Trusted Proxy Page and a trusted Third Party Processor “bank”.

Starting in the top right corner, Step 1 depicts an end-user accessing User Interface 110 (“Web Browser”) and clicking a “buy” button displayed by the “Online Merchant Application” in Application Server 105 of “Merchant” Publisher 100.

Step 2 depicts the merchant responding to the End User's “buy” request and calling for a payment form from Secure Application 310.

Step 3 depicts the merchant displaying a branded interface to the web browser. For example, but not by way of limitation, the branded interface incorporating a website template incorporating logos, menus and other elements of the distrusted online merchant application.

Step 4 depicts the Secure Application 310 of the system displaying a trusted credit card data form (Trusted Proxy Frame) within the distrusted branded interface of Step 3.

Step 5 depicts the End user entering and submitting credit card data (Primary Information) into the trusted credit card data form of Secure Application 310.

Step 6 depicts Secure Application 310 processing and forwarding the received card data to a bank (Third-Party Processor 800).

Step 7a depicts the bank returning the processed transaction response data to the merchant.

Step 7b depicts the bank concurrently returning a response to Secure Application 310.

Step 8a depicts the merchant recording the bank transaction response data of Step 7a.

Step 8b depicts the trusted card data form of Secure Application 310 sending a transaction message to the End User's web browser. For example, but not by way of limitation, the message consisting of the process transaction response of the bank.

Step 9 depicts the web browser pushing the transaction message response of Step 8b from the trusted domain (DOM) of Secure Application 310 to a Primary Function 240a in the distrusted March and domain. For example, but not by way of limitation, the Primary Function 240a comprising a component of an online merchant application.

Step 10 depicts the merchant displaying the final transaction response to the End-User via the web browser.

The embodiments of the system depicted in this and other figures prevent unauthorized and distrusted agents from accessing or interacting with Primary Information 150. For example, but not by way of limitation, criminal intercept or observation.

FIG. 5A is a system diagram depicting an embodiment of the system in context with an initiating process of a primary information transaction. FIG. 5A depicts a human end user interacting with User Interface 110 to begin a purchase checkout at online merchant 100. FIG. 5A includes elements of FIGS. 1 and 2.

In FIG. 5A, User Interface 110 initiates communications with Primary Function 240a via network Segments 160 and 160b. FIG. 5B is a diagram depicting components of the system. FIG. 5B incorporates the elements of FIG. 5A and adds Secure Server 300, Secure Server Application 310, Gatekeeper Process 505, Transaction Process 507 and Communication Segment 515 of FIG. 2.

FIG. 5C is a diagram depicting elements of the system. FIG. 5C incorporates the elements of FIG. 5B and adds Trusted Frame Process 510 and Authentication Key 571a. Trusted Frame Process 510 is a computing construct of the system. Authentication Key 571a is a computing construct of the system that embodies authentication algorithms. Examples of Authentication Key 571a authentication algorithms include encrypted key exchange protocols, such as public/private key encryption mechanisms.

FIG. 5D is a diagram depicting an embodiment of the system. FIG. 5D incorporates the elements of FIG. 5C and adds Trusted Proxy Frame 1620 of FIG. 2, Primary Function 240b, Local Domain Frame 242b and WAN 320. FIG. 5D also includes dashed lines 611, 613, 618, 620 and 645a. Primary Function 240b and Local Domain Frame 242b represent the transformation of Primary Function 240a and Local Domain Frame 242a, respectively, by processes of the system.

Step 1 and dashed line 611 of FIG. 5D depicts a human end user interacting with User Interface 110 to launch a “buy now” checkout process within Primary Function 240b.

Step 2 and dashed line 618 depict a request by Application Server 105 for a trusted data form from Secure Server 300.

Step 3 and dashed line 620 depict the Trusted Proxy Frame 1620 response of Secure Server 300.

Step 4 and dashed line 645a depict the integration of the Trusted Proxy Frame 1620. As Trusted Proxy Frame 1620 is integrated within the E-commerce functions of Application Server 105, Primary Function 240a and Local Domain Frame 242a of FIG. 5C transforms to Primary Function 240b and Local Domain Frame 242b, respectively.

Step 5 depicts Primary function 240b presentation of the transformed Local Domain Frame 242b to User Interface 110 as the application and data entry interface for the Primary Information transaction.

As illustrated by dashed line 645a, the system creates a logical trusted relationship between Trusted Proxy Frame 1620 and Trusted Frame Process 510 that persists for the duration of the Primary Information exchange process. This trusted relationship creates a segregated communication conduit that facilitates policy enforcement for Primary Information. Algorithms of the system create Authentication Key 571a and use this key to periodically validate the authenticity of these endpoints during a Primary Information exchange process. Exemplary authentication methods include encrypted key exchange protocols, such as public/private key encryption mechanisms.

FIG. 5E is a diagram depicting an embodiment of the system. FIG. 5E incorporates the elements of FIG. 5D and adds Computer Malware 106 of FIG. 1, Authentication Key 571b and dashed line 710.

Authentication Key 571b is a computing construct of the system that embodies the authentication algorithms of Authentication Key 571a as it moves from Trusted Frame Process 510 to Trusted Proxy Frame 1620.

As depicted in Step 1 of FIG. 5, using the trusted communication conduit depicted by dashed line 710, Primary Information 150 transits from User Interface 110 directly into Trusted Proxy Frame 1620 via Communication Segments 160a-b, Application Server 105 and Publisher Application 640.

Trusted Proxy Frame 1620 receives Primary Information 150 and initiates communication between Trusted Proxy Frame 1620 and Gatekeeper Process 505.

The embodiments of the system depicted in this and other figures prevent unauthorized and distrusted agents from accessing or interacting with Primary Information 150. For example, but not by way of limitation, from intercept or observation by Computer Malware 106.

FIG. 5F is a diagram depicting an embodiment of the system. FIG. 5F incorporates the elements of FIG. 5E and adds Third-Party Data Processor 800, Third-Party Processing Algorithm 810, Transactional Process 840 and WAN 820 of FIG. 2, Authentication Key 571c, and dashed line 720a.

Authentication Key 571c is a computing construct of the system that embodies the authentication algorithms of Authentication Keys 571a-b as it moves from Trusted Proxy Frame 1620 to Gatekeeper Process 505.

In FIG. 5F, Trusted Proxy Frame 1620 combines Primary Information 150 and Authentication Key 571b. As depicted by dashed line 720a, it sends the information as Primary Information 150 and Authentication Key 571c, which is received by Secure Server 300, Secure Server Application 310 and Gateway Process 505.

The embodiments of the system depicted in this and other figures prevent unauthorized and distrusted agents from accessing or interacting with Primary Information 150. For example, but not by way of limitation, from intercept or observation by Computer Malware 106.

FIG. 5G is a diagram depicting an embodiment of the system. FIG. 5G incorporates the elements of FIG. 5F and adds Authentication Key 571d.

Authentication Key 571d is a computing construct of the system that embodies the authentication algorithms of Authentication Keys 571a-c as it moves from Gatekeeper Process 505 to Third-Party Data Processor 800.

As represented by dashed line 720b of FIG. 5G, Gatekeeper Process 505 forwards the Primary Information 150 and Authentication Key 571d to Third-Party Data Processor 800 via Transaction Process 507, Transactional Process 840 and WAN 820.

As depicted by Authentication Key 571d, Transaction Process 507 holds authentication credentials for Primary Information 150 as it transits to Third-Party Data Processor 800.

Upon receipt of Primary Information 150, Third-Party Data Processor 800 interacts with it according to policies and algorithms defined within Third-Party Processing Algorithm 810.

The embodiments of the system depicted in this and other figures prevent unauthorized and distrusted agents from accessing or interacting with Primary Information 150. For example, but not by way of limitation, from intercept or observation by Computer Malware 106.

FIG. 5H is a diagram depicting an embodiment of the system. FIG. 5H incorporates the elements of FIG. 5G and adds Result Data Object 950, Surrogate Information Data Object 952, Remote Domain Callback Process 1630a-c, Authentication Key 571e and dashed lines 920, 946 and 948.

Result Data Object 950 is a computing construct that embodies transaction response data from Third-Party Data Processor 800. For example, but not by way of limitation, an XML document containing a tokenized representation of Primary Information 150.

Surrogate Information Data Object 952 is a computing construct that embodies an abstracted surrogate of the Primary Information that can be shared in a distrusted environment without violating Primary Information handling policies. For example, but not by way of limitation, an XML document containing the last four digits of a Social Security number, a portion of a credit card number, etc.

Remote Domain Callback Process 1630a-c are computing constructs of the system. For example, but not by way of limitation, HTML documents.

Authentication Key 571e is a computing construct of the system that embodies the authentication algorithms of Authentication Keys 571a-d as it moves from Third-Party Data Processor 800 to Trusted Frame Process 510.

As depicted by dashed line 920 of FIG. 5H, Result Data Object 950 is communicated from Third-Party Data Processor 800 through Transactional Process 840, Transaction Process 507, Gatekeeper Process 505 to Trusted Frame Process 510.

As depicted by dashed line 948, Gatekeeper Process 505 returns Surrogate Information Data Object 952 to Application Server 105 via WAN 320.

As depicted by dashed line 946, Trusted Frame Process 510 incorporates the transaction results contained within Result Data Object 950 into the template of Remote Domain Callback Process 1630b. Trusted Frame Process 510 then forwards the formatted transaction results via WAN 320 to Remote Domain Callback Process 1630a and returns process and input control to Application Server 105 upon completion of the Primary Information transaction.

Remote Domain Callback Process 1630a then forwards the formatted transaction results to Remote Domain Callback Process 1630c, where they are presented to User Interface 110.

The embodiments of the system depicted in this and other figures prevent unauthorized and distrusted agents from accessing or interacting with Primary Information 150. For example, but not by way of limitation, from intercept or observation by Computer Malware 106.

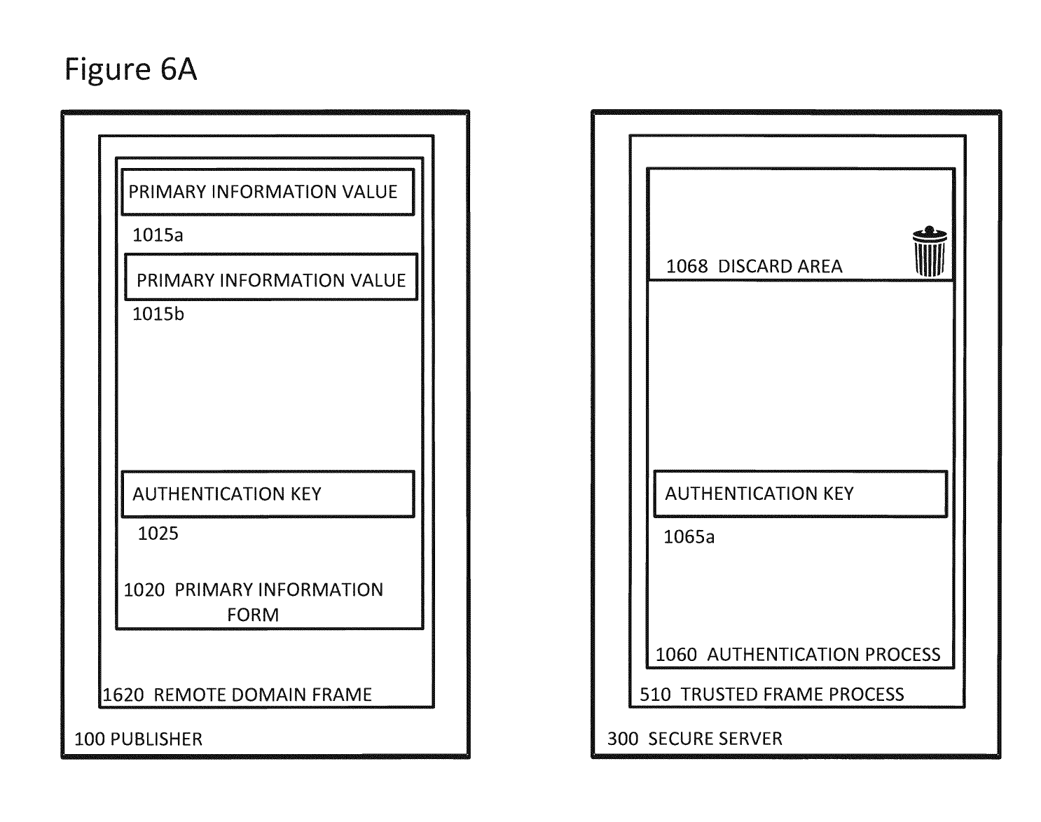

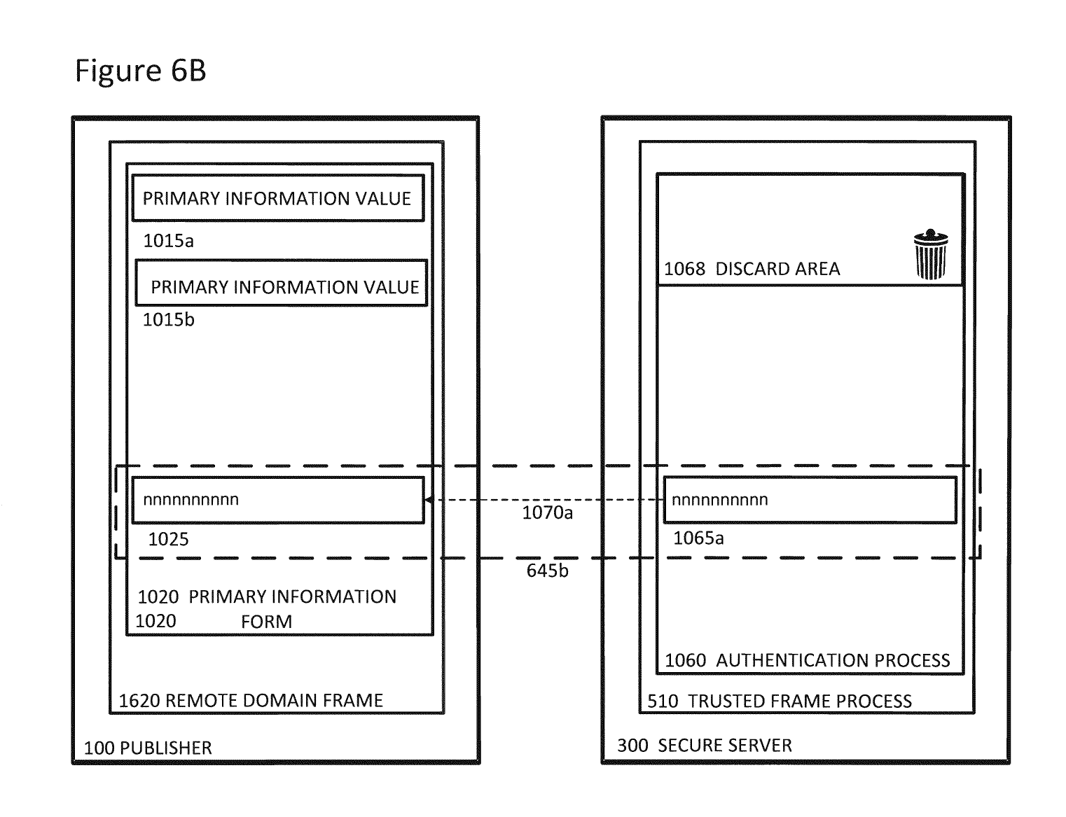

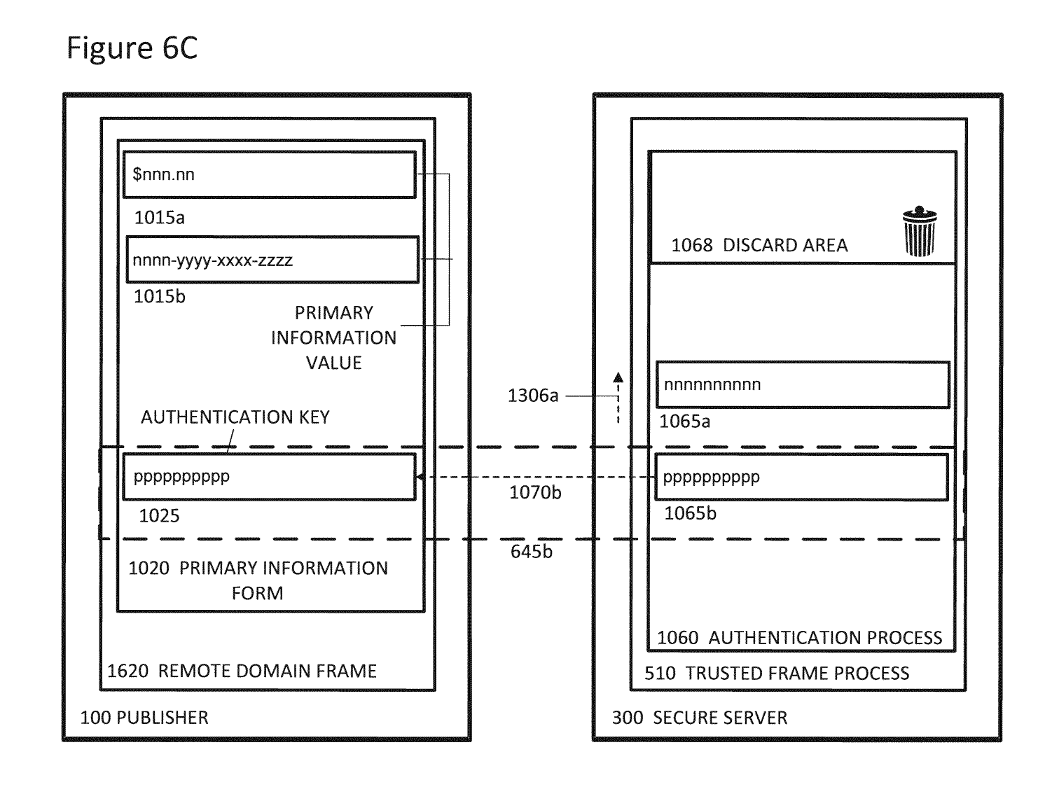

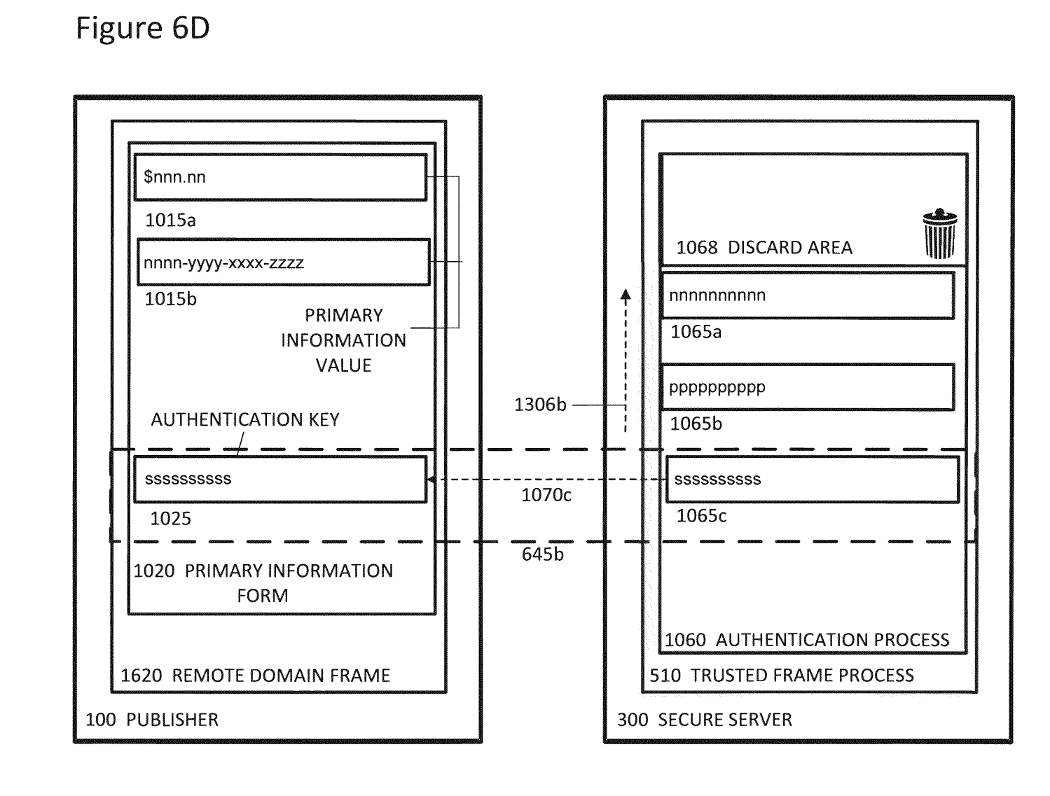

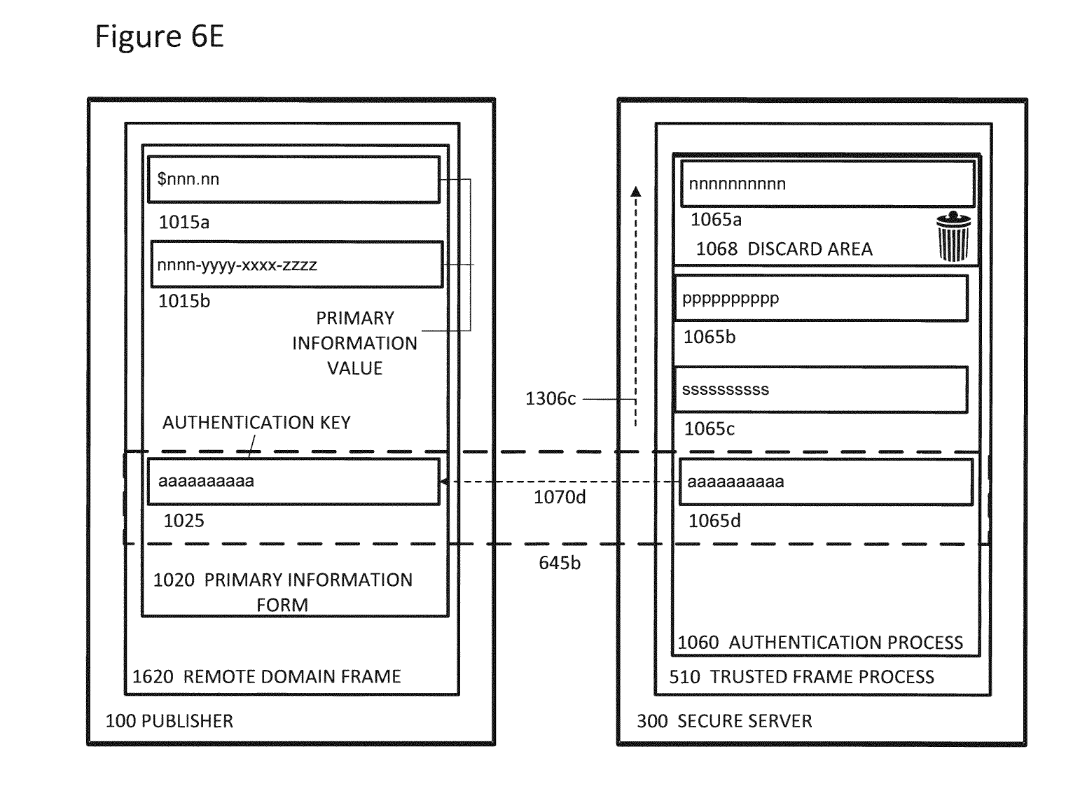

FIG. 6A is a logical flow diagram depicting the initiation of an authentication key exchange of the system. FIG. 6A includes Publisher 100, Secure Server 300, Trusted Proxy Frame 1620 and Trusted Frame Process 510 of FIG. 1. FIG. 6A adds Sensitive Data Form 1020, Authentication Key 1025, Primary Information Values 1015a-b, Authentication Process 1060, Discard Area 1068 and Authentication Key 1065a.

Authentication Keys 1025 and 1065a are computing constructs of the system. An exemplary instance is an encrypted public/private key identity authentication value.

Primary Information Values 1015 are electronic data elements. Exemplary instances include a credit card number and cardholder name.

Sensitive Data Form 1020 is a computing construct of the system that embodies Primary Information Values 1015a-b and Authentication Key 1025. An exemplary instance is an HTML document.

Authentication Process 1060 is a computing construct of the system. An exemplary instance is a database table configured to record valid authentication key values.

Discard Area 1068 is a computing construct of the system. An exemplary instance is a “deleted records” database table.

FIG. 6B is a logical flow diagram depicting an intermediary step in an authentication key exchange of the system. FIG. 6B incorporates the elements of FIG. 6A and adds dashed line 1070a and Trusted Relationship 645b.

As depicted by the dashed box of FIG. 6B, Trusted Relationship 645b is a computing process of the system that embodies comparable characteristics to the relationship depicted by dashed line 645a in FIG. 5D.

As depicted by dashed line 1070a, Authentication Process 1060 communicates with Trusted Proxy Frame 1620 and creates Trusted Relationship 645b with endpoint identities validated by Authentication Keys 1025 and 1065a.

Trusted Relationship 645b facilitates a trusted conduit to communicate Primary Information Values 1015a-b between Sensitive Data Form 1020, Trusted Proxy Frame 1620 and elements of the system embodied within Secure Server 300.

FIG. 6C is a logical flow diagram depicting an intermediary step in an authentication key exchange of the system. FIG. 6C incorporates the elements of FIG. 6B and adds Authentication Key 1065b and dashed lines 1070b and 1306a.

Authentication Key 1065b is a computing construct of the system with comparable characteristics to Authentication Key 1065a.

As depicted by dashed line 1306a, after a predetermined time the Trusted Relationship 645b between Authentication Keys 1025 and 1065a expires. Authentication Key 1065a is removed from Trusted Relationship 645b and transferred to a temporary storage location within Authentication Process 1060. As depicted by dashed line 1070b, Authentication Process 1060 replicates processes represented by dashed line 1070a of FIG. 6B. These processes create a new Trusted Relationship 645b between Authentication Keys 1025 and 1065b.

FIG. 6D is a logical flow diagram depicting an intermediary step in an authentication key exchange of the system. FIG. 6D incorporates the elements of FIG. 6C and adds Authentication Key 1065c and dashed lines 1070c and 1306b.

As depicted by dashed line 1306b, after a predetermined time the Trusted Relationship 645b between Authentication Keys 1025 and 1065b expires. Authentication Key 1065b is removed from Trusted Relationship 645b and transferred to a temporary storage location within Authentication Process 1060. As depicted by dashed line 1070c, Authentication Process 1060 replicates processes represented by dashed line 1070a of FIG. 6B. These processes create a new Trusted Relationship 645b between Authentication Keys 1025 and 1065c.

FIG. 6E is a logical flow diagram depicting a terminal step in an authentication key exchange of the system. FIG. 6E incorporates the elements of FIG. 6D and adds Authentication Key 1065d and dashed lines 1070d and 1306c.

As depicted by dashed line 1306c, after a predetermined time the Trusted Relationship 645b between Authentication Keys 1025 and 1065c expires. Authentication Key 1065c is removed from Trusted Relationship 645b and transferred to a temporary storage location within Authentication Process 1060. As depicted by dashed line 1070b, Authentication Process 1060 replicates processes represented by dashed line 1070a of FIG. 6B. These processes create a new Trusted Relationship 645b between Authentication Keys 1025 and 1065d.

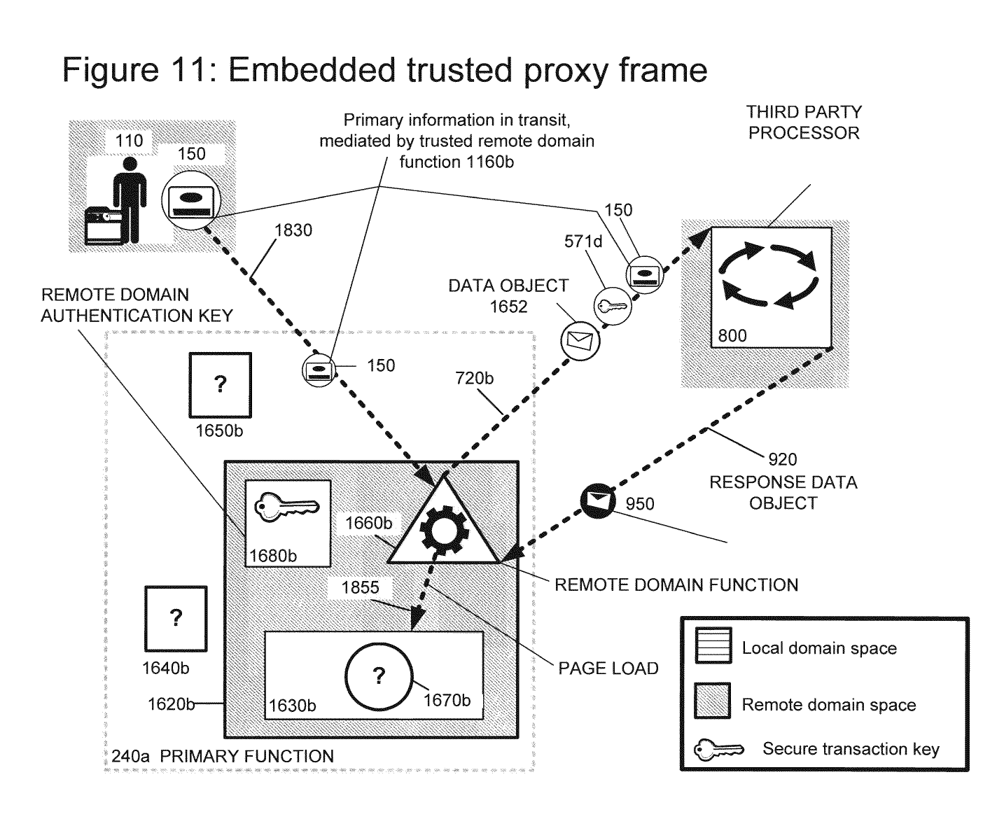

In the exemplary configuration of FIGS. 11-15, Authentication Process 1060 is configured to retain the three most recent Authentication Keys used by Trusted Relationship 645b. With the introduction of Authentication Key 1065d, the original Authentication Key 1065a completely expires and is moved into Discard Area 1068 where it is destroyed.

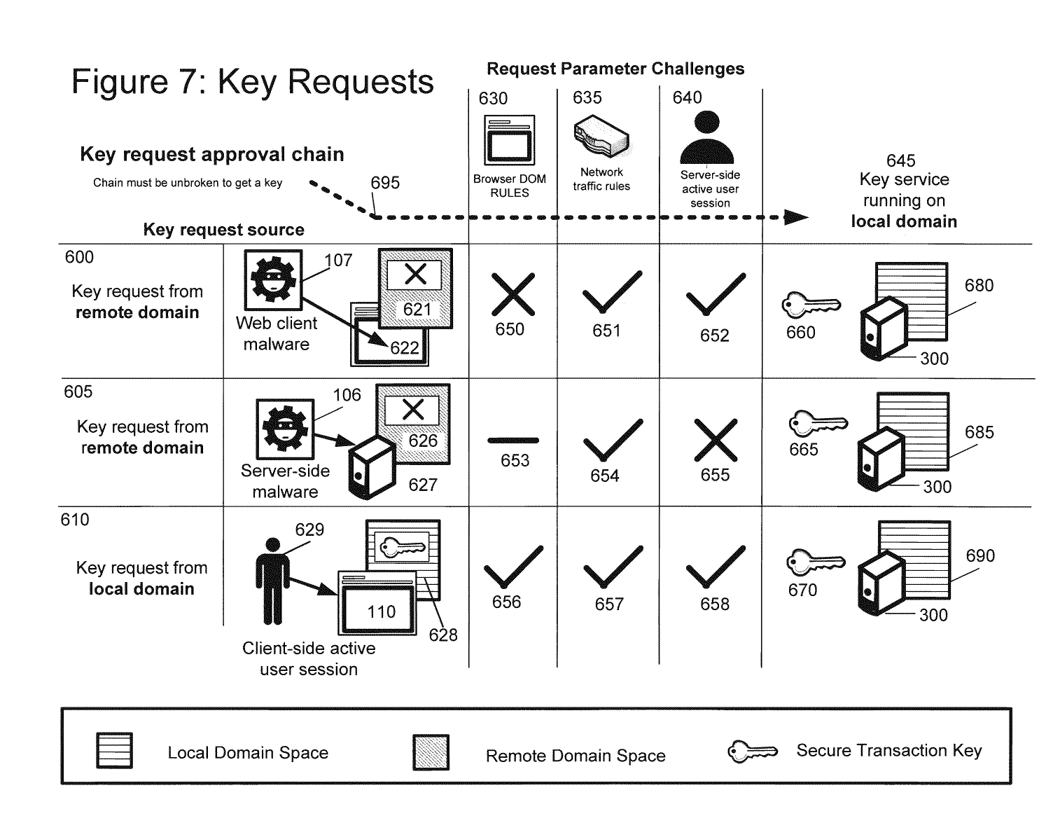

FIG. 7 is a logical flow diagram depicting an authentication key approval process of the system. FIG. 7 is a system diagram illustrating key elements and process flows of three different key request chain scenarios.

FIG. 7 includes Secure Server 300, User Interface 110 and Criminal Malware 106 of FIG. 1.

FIG. 7 is configured as a grid of four rows and six columns depicting three alternate key request scenarios being run against three request parameter challenges and the respective results.

Starting in the top left corner, the top row provides a legend that depicts, in columns from left to right, a key request source, Key Request Chain 695, Browser Domain Challenge 630, Network Traffic Challenge 635, Active User Session Challenge 640 and Key Service 645.

In the second row, moving left to right, Key Request 600 includes Computer Malware 107, Domain 621, Browser 622, Transaction Parameters 650, 651 and 652, Authentication Key 660, Secure Server 300 and Domain 680.

In the third row, moving left to right, Key Request 605 includes Computer Malware 106, Domain 626, Server 627, Transaction Parameters 653, 654, 655, Authentication Key 665, Secure Server 300 and Domain 685.

In the bottom row, moving left to right, Key Request 610 includes Client-Side Active User Session 629, User Interface 110, Domain 628, Transaction Parameters 656, 657, 658, Authentication Key 670 Secure Server 300 and Domain 690.

The embodiments of the system depicted in this and other figures prevent unauthorized and distrusted agents from accessing or interacting with Primary Information. For example, but not by way of limitation, from intercept or observation by computer malware.

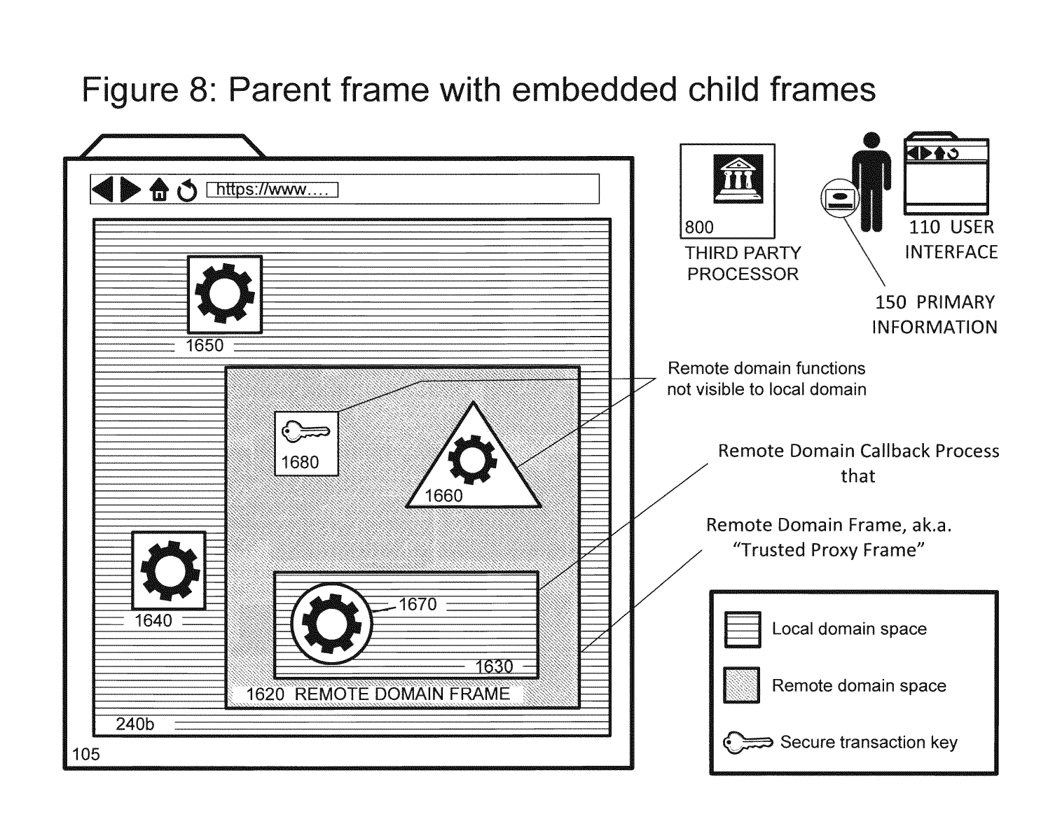

FIG. 8 is a system diagram illustrating a Trusted Proxy Frame and key elements in its environment. Starting at the bottom left corner and proceeding in approximately counter-clockwise order, key elements of FIG. 8 include:

Application Server 105, Primary Function 240a-b, Trusted Proxy Frame 1620a-c, Remote Domain Callback Process 1630a-c, Primary Information 150, User Interface 110 and Third-Party Data Processor 800 of preceding figures.

FIG. 8 adds Local Domain Function 1640, Local Domain Function 1650, Remote Domain Function 1660, Local Domain Function 1670 and Remote Domain Authentication Key 1680.

Local Domain Function 1640 is an algorithm of the Primary Function. For example, but not by way of limitation, a process configured to receive a transaction completion result data object or signal and execute a predefined process.

Local Domain Function 1650 is an algorithm of the Primary Function. For example, but not by way of limitation, a process configured to receive a transaction initiation data object or signal and execute a predefined process.

Remote Domain Function 1660 is an algorithm of the system. For example, but not by way of limitation, a process with the ability to receive a Primary Information transaction request from the local domain of a Publisher, mediate a transaction process within a remote domain of a publisher involving an End User and a Third Party Processor, and to return a transaction result to the local domain of the Publisher.

Local Domain Function 1670 is an algorithm of the system. For example, but not by way of limitation, a process configured to return a transaction result.

Remote Domain Authentication Key 1680. An authentication key associated with the remote domain of the system.

Although the Primary Function 240a interface comprises elements from both local and remote domains which enforce controls that keep the domains logically separated, it is important to note that from the aesthetic perspective of an End User interface, such as a exemplary web browser, the logical separation of domains is completely transparent. An End User sees all elements in the same visual depiction. It is through the function of the system that the unseen logical domain separation can be transited by elements of a Primary Information transaction.

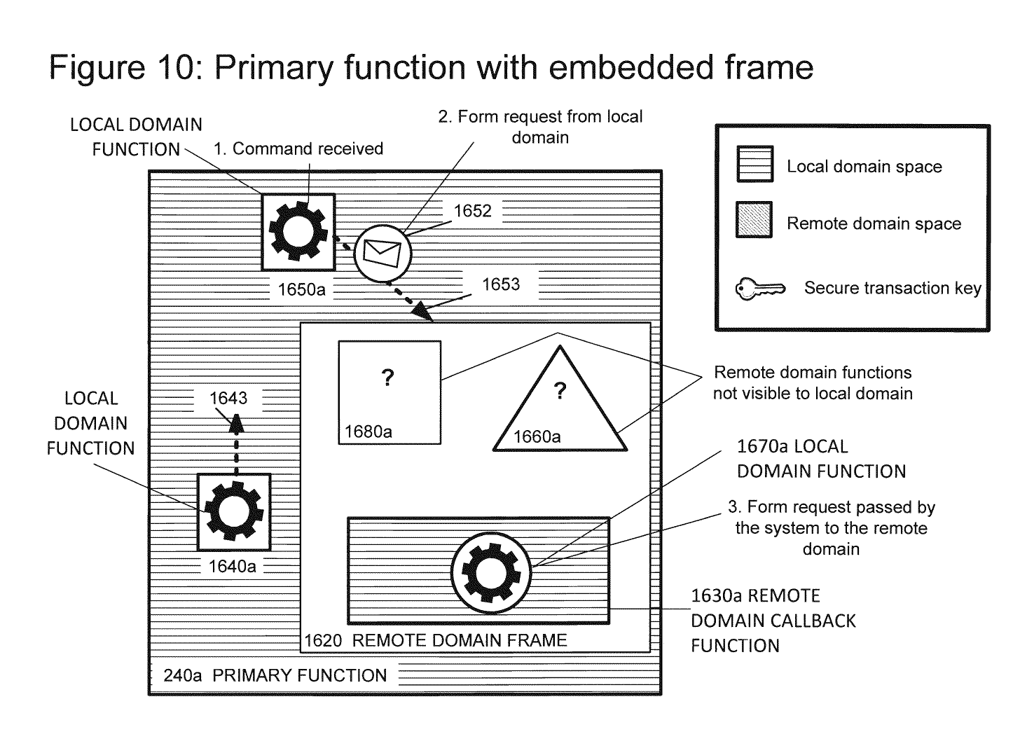

The interaction of elements depicted in FIG. 8 are illustrated in greater detail in FIGS. 10-12. The embodiments of the system depicted in this and other figures prevent unauthorized and distrusted agents from accessing or interacting with Primary Information 150, for example, but not by way of limitation, from intercept or observation by computer malware.

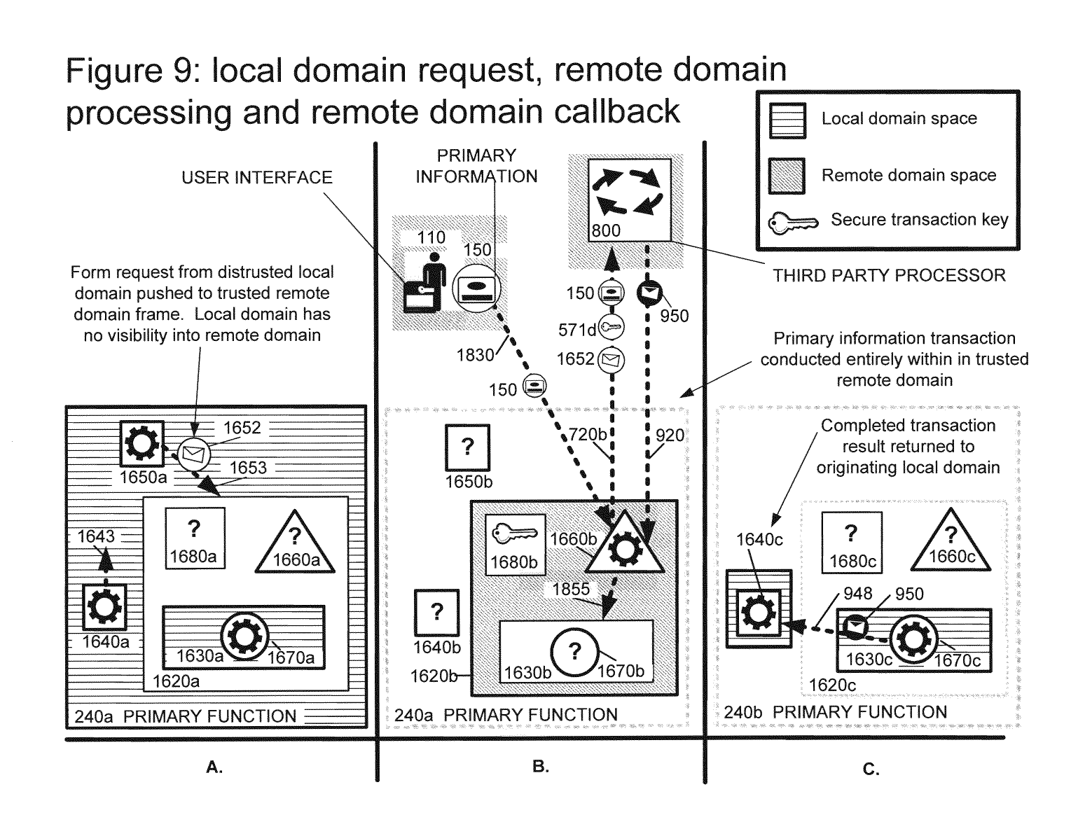

FIG. 9 is a system diagram illustrating key elements and process flows that launch and interoperate with a trusted proxy frame. FIG. 9 incorporates elements of FIG. 8 presented in three columns labeled A-C, representing their appearance in three different application perspectives.

FIG. 9 adds User Interface 110, Primary Information 150, Authentication Key 571d, result Data Object 950, Data Communication 720b, Data Communication 948 and Third-Party Processor 800 of preceding figures. FIG. 9 also adds Data Object 1652, page load Function 1653 and Data Communication 1643.

The leftmost Column A represents the perspective from the local domain of Primary Function 240a and Publisher 100. Column A includes Primary Function 240a, which embodies Function 1640a, Function 1650a and Remote Domain Frame 1620a.

Remote Domain Frame 1620a embodies Remote Domain Callback Process 1630a, Remote Domain Callback Process 1630a also embodying Local Domain Function 1670a. Remote Domain Frame 1620a also embodies placeholders representing Remote Domain Authentication Key 1680a and Remote Domain Function 1660a.

Primary Function 240a also embodies Data Communication 1643, Data Communication 1653 and Data Object 1652.

The center Column B represents the application perspective of the Remote Domain Frame of the system. According to another aspect of the system, the Remote Domain Frame is known as a Trusted Proxy Frame.

Column B includes Primary Function 240b, which embodies Remote Domain Frame 1620b, as well as empty placeholders representing Local Domain Function 1640b and Local Domain Function 1650b.

Remote Domain Frame 1620b embodies Remote Domain Authentication Key 1680b, Remote Domain Function 1660b, Data Communication 1855 and Remote Domain Callback Process 1630b, Remote Domain Callback Process 1630b also embodying a placeholder for Local Domain Function 1670b.

Column B also includes User Interface 110, Primary Information 150. Column B also includes Third-Party Processor 800, Data Communication 720b, Data Object 1652, Authentication Key 571d, Data Object 950 and Data Communication 920, dashed line 1830.

The right column, Column C represents the application perspective of Remote Domain Callback Process 1630c. Column C includes Primary Function 240c, which embodies Local Domain Function 1640c and a placeholder representing Remote Domain Frame 1620c.

The placeholder for Remote Domain Frame 1620c embodies Remote Domain Callback Process 1630c, Remote Domain Callback Process 1630c also embodying Local Domain Function 1670c, Data Communication 948 and Result Data Object 950. The placeholder for Remote Domain Frame 1620c also embodies placeholders for Remote Domain Authentication Key 1680c and Remote Domain Function 1660c.

The interaction between the elements depicted in FIG. 9 are illustrated in greater detail in FIGS. 10-12. The embodiments of the system depicted in this and other figures prevent unauthorized and distrusted agents from accessing or interacting with Primary Information 150, for example, but not by way of limitation, from intercept or observation by computer malware.

FIG. 10 is a system diagram depicts the elements and perspective of FIG. 9, Column A. It illustrates key elements and process flows of a frame of the Primary Function parent frame with an embedded Remote Domain Frame, the Remote Domain Frame also known as Trusted Proxy Frame. FIG. 10 represents the perspective from the local domain of Primary Function 240a and Publisher 100.

Column A includes Primary Function 240a, which embodies Function 1640a, Function 1650a and Remote Domain Frame 1620a. Remote Domain Frame 1620a embodies Remote Domain Callback Process 1630a, Remote Domain Callback Process 1630a also embodying Local Domain Function 1670a. Remote Domain Frame 1620a also embodies placeholders representing Remote Domain Authentication Key 1680a and Remote Domain Function 1660a.

Primary Function 240a also embodies Data Communication 1643, Data Communication 1653 and Data Object 1652.

In Step 1 FIG. 10, Local Domain Function 1650a receives a command from an authorized agent. For example, but not by way of limitation, the command being initiated by an End User clicking a “buy” button and the agent being an e-commerce shopping cart interface.

In Step 2, Local Domain Function 1650a executes a predetermined function to launch a form request, depicted by Data Object 1652 and page load Function 1653. For example, but not by way of limitation, the page load being for a trusted Remote Domain Frame, also known as a Trusted Proxy Frame.

In Step 3, the former request is passed to a remote domain via Local Domain Function 1670a.

As depicted by the placeholder elements, Remote Domain Function 1660a And Remote Domain Function 1680 are not visible from the local domain of Primary Function 240a.

The embodiments of the system depicted in this and other figures prevent unauthorized and distrusted agents from accessing or interacting with Primary Information 150. For example, but not by way of limitation, from intercept or observation by computer malware.

FIG. 11 includes the elements of FIG. 9, Column B and depicts the application perspective of Remote Domain Frame. FIG. 11 is a system diagram illustrating key elements and process flows of a Trusted Proxy Frame. According to another aspect of the system, the Trusted Proxy Frame is known as a Remote Domain Frame.

FIG. 11 represents the application perspective of the Remote Domain Frame 1620 of the system. FIG. 11 includes Primary Function 240b, which embodies Remote Domain Frame 1620b, as well as empty placeholders representing Local Domain Function 1640b and Local Domain Function 1650b. The empty placeholders illustrate the lack of visibility and data access between the local domain of the Primary Function and the remote domain of the system.

Remote Domain Frame 1620b embodies Remote Domain Authentication Key 1680b, Remote Domain Function 1660b, Data Communication 1855 and Remote Domain Callback Process 1630b, Remote Domain Callback Process 1630b also embodying a placeholder for Local Domain Function 1670b.

Column B also includes User Interface 110, Primary Information 150. Column B also includes Third-Party Processor 800, Data Communication 720b, Data Object 1652, Authentication Key 571d, Result Data Object 950 and Data Communication 920 and dashed line 1830.

In FIG. 11, the form request forwarded via Local Domain Function 1670a (depicted as Local Domain Function 1670b in this perspective) is processed by Remote Domain Function 1660b. Remote Domain Function 1660b presents a Primary Information data collection interface to and End User via User Interface 150.

The input of Primary Information 150 is returned, as depicted by Data Communication 1830, to Remote Domain Function 1660b.

As depicted by Data Communication 720b, Remote Domain Function 1660b then forwards Primary Information 150, Authentication Key 571d and Data Object 1652 to Third Party Processor 800.

As depicted by Data Communication 920, Third-Party Processor 800 returns Result Data Object 950 to Remote Domain Function 1660b. For example, but not by way of limitation, Result Data Object 950 comprising actionable transaction response data that does not contain or expose the content of Primary Information 150.

As depicted by Data Communication 1855, Remote Domain Function 1660b forwards Result Data Object 950 back to the local domain on the Primary Function via Local Domain Function 1670b.

Of note, processes and the interactions of Remote Domain Function 1660b are not visible from the local domain of the Primary Function 240a.

The embodiments of the system depicted in this and other figures prevent unauthorized and distrusted agents from accessing or interacting with Primary Information 150, for example, but not by way of limitation, from intercept or observation by computer malware.

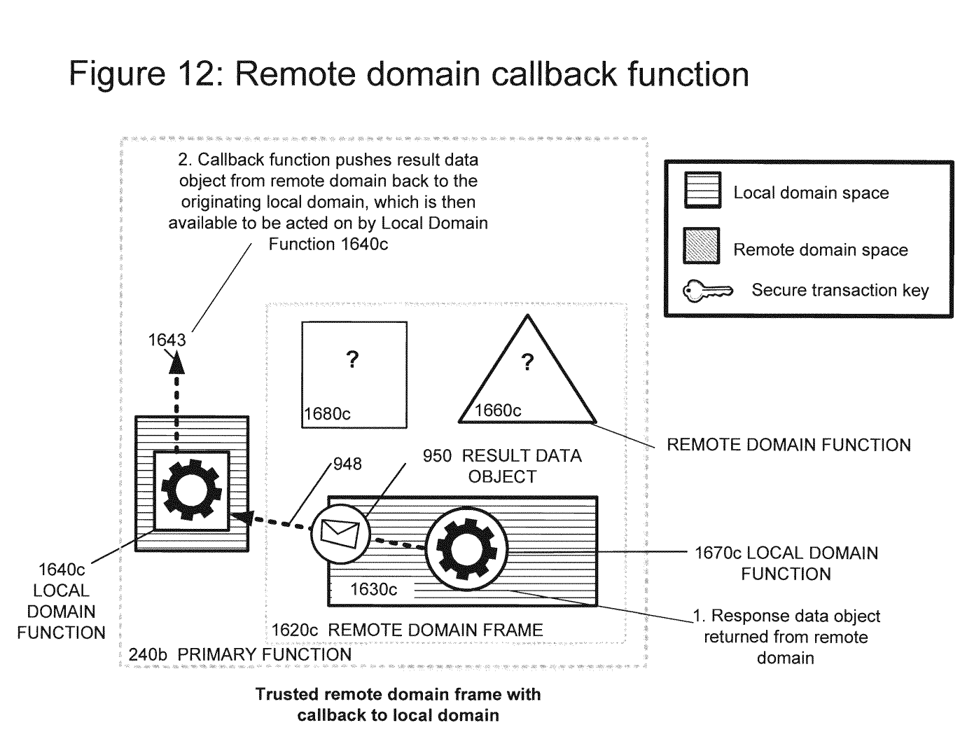

FIG. 12 includes the elements of FIG. 9, Column C and depicts the application perspective of Remote Domain Callback Process 1630. FIG. 12 is a system diagram illustrating key elements and process flows of a second child frame with local content. FIG. 12 represents the application perspective of Remote Domain Callback Process 1630c.

Column C includes Primary Function 240c, which embodies Local Domain Function 1640c and a placeholder representing Remote Domain Frame 1620c. The placeholder for Remote Domain Frame 1620c embodies Remote Domain Callback Process 1630c, Remote Domain Callback Process 1630c also embodying Local Domain Function 1670c, Data Communication 948 and Result Data Object 950. The placeholder for Remote Domain Frame 1620c also embodies placeholders for Remote Domain Authentication Key 1680c and Remote Domain Function 1660c.

As depicted in Step 1, Result Data Object 950 is returned from the remote domain by Remote Domain Function 1660c.

Result Data Object 950 is manipulated by Remote Domain Callback Process 1630c.

As illustrated by Data Communication 948, Result Data Object 950 is forwarded to Local Domain Function 1640c.

As depicted by Data Communication 1643, Local Domain Function 1640c and then execute a predetermined computing function. For example, but not by way of limitation, sending a signal to the originating e-commerce application that the purchase transaction has been approved and is complete.

As illustrated by the placeholder, Remote Domain Function 1660 is not visible from the local domain of the Primary Function 240b. The

The embodiments of the system depicted in this and other figures prevent unauthorized and distrusted agents from accessing or interacting with Primary Information 150, for example, but not by way of limitation, from intercept or observation by computer malware.

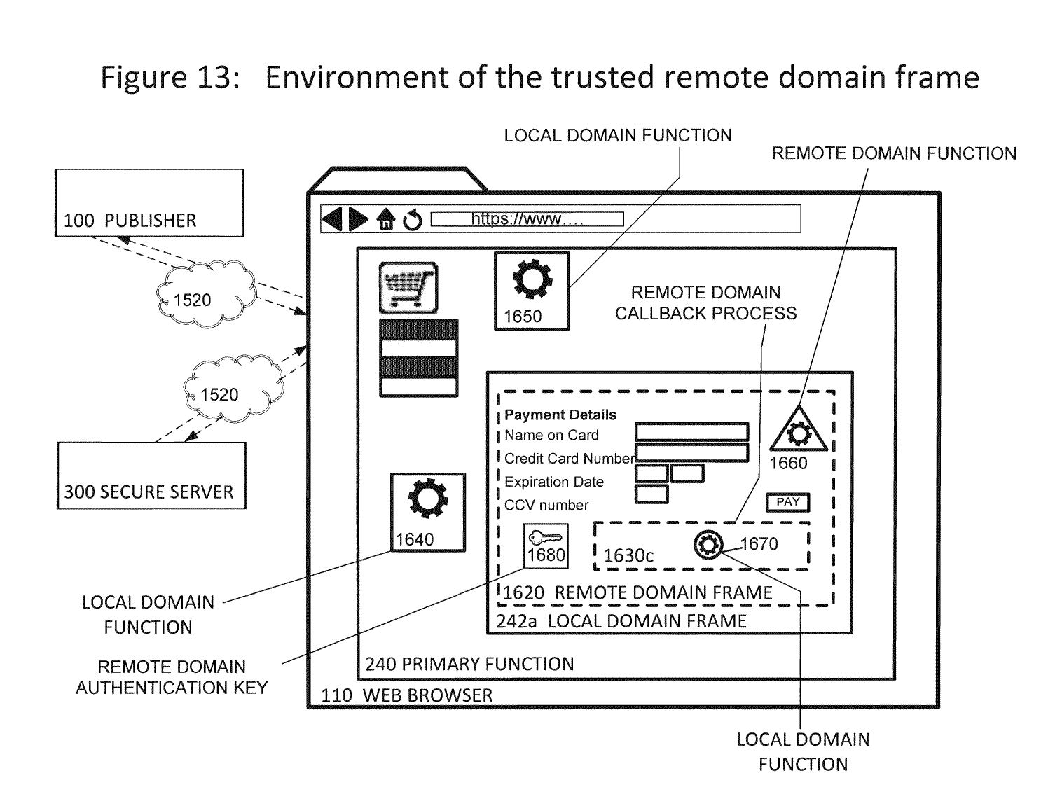

FIG. 13 is a diagram depicting a nested relationship among components of the system and between the system and its environment. FIG. 13 includes the Publisher 100, Application Server 105, Primary Function 240 and Local Domain Frame 242 elements of FIG. 5A. FIG. 13 also includes Trusted Proxy Frame 1620 elements of FIG. 5D and Remote Domain Callback Process 1630c of FIG. 5H.

The Primary Function 240a interface comprises elements from both local and remote domains, with enforced controls that keep the domains logically separated.

It is important to note that from the aesthetic perspective of an End User interface, such as the exemplary Web Browser 110, the logical separation of domains is completely transparent. An End User sees all elements in the same visual depiction. It is through the function of the system that the unseen logical domain separation can be transited by elements of a Primary Information transaction.

The embodiments of the system depicted in this and other figures prevent unauthorized and distrusted agents from accessing or interacting with Primary Information 150, for example, but not by way of limitation, from intercept or observation by computer malware.

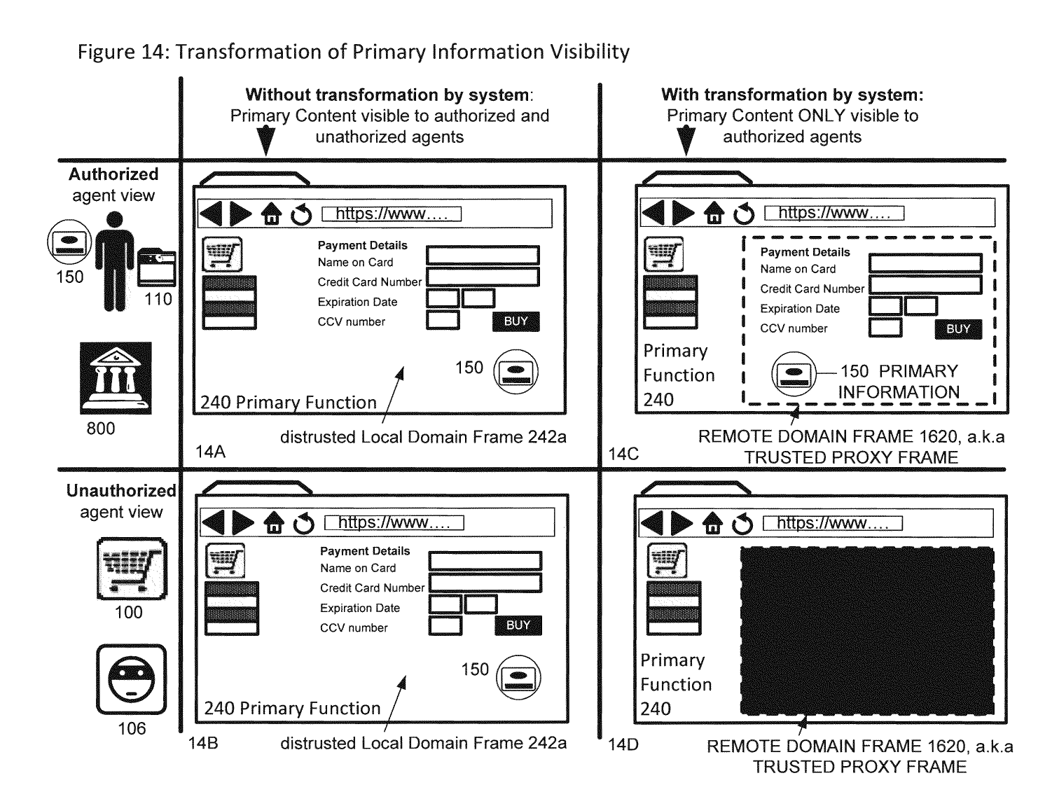

FIG. 14 is a logical diagram depicting an embodiment of the system in context with the transformation of a user interface display.

The Primary Function 240a interface comprises elements from both local and remote domains, with enforced controls that keep the domains logically separated.

It is important to note that from the aesthetic perspective of an End User interface, such as the exemplary Web Browser 110, the logical separation of domains is completely transparent.

As depicted in Box 14A, in a conventional Primary Function 240 interface, an authorized End User sees all elements. For example, but not by way of limitation, branded elements and data collection forms.

As depicted in Box 14C, this presentation is aesthetically unchanged even after transformation of by system. An End User sees all elements in the same visual depiction. It is through the function of the system that the unseen logical domain separation can be transited by elements of a Primary Information transaction.

As depicted in Box 14B, in a conventional Primary Function 240 interface, an unauthorized user also sees all elements. For example, but not by way of limitation, a distrusted Publisher 100 or criminal malware 106. As a result, any entry of Primary Information 150 Primary Function 240 is vulnerable to criminal intercept or exploit.

In contrast, and as depicted in Box 14D, after transformation by the system, an unauthorized user can see non-sensitive elements of Primary Function 240, but they have no visibility or access to sensitive Primary Information 150.

The embodiments of the system depicted in this and other figures prevent unauthorized and distrusted agents from accessing or interacting with Primary Information 150. For example, but not by way of limitation, from intercept or observation by computer malware.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. A system for providing a trusted computing function of a third party data processor on behalf of a networked publisher in connection with providing a networked computing function for an end user by the publisher, the third party data processor requiring sensitive information of an end user, the publisher operating a distrusted server coupled to a data communication network, the distrusted server including a distrusted end user interface, a processor for executing computer program modules and a memory; the system comprising:
a secure server coupled to the data communications network, the secure server including a processor for executing computer program modules and a memory;
a data communications interface for trusted communications between the distrusted server of the publisher and an end user, trusted communications between the distrusted server of the publisher and the secure server, and trusted communications between the secure server and the third party data processor; and
a security function computer program module executable on the secure server, the security function program module operative to:
(a) receive an incoming communication (URL submission) from a calling function computer program module of the publisher via the data communications interface;
(b) receive an incoming communication from the publisher via the data communications interface, the incoming communication including contemporary specific attribute parameters of the calling function computer program module of the publisher;
(c) execute a trusted transaction interface function computer program module on the secure server to create a trusted user interface computer program module executable on an end user's computer (e.g. JavaScript object);
(d) send an outgoing communication from the security function computer program module to the publisher via the data communications interface, the outgoing communication including the trusted user interface computer program module (e.g. the JavaScript object), the calling function computer program module of the publisher receiving the trusted user interface computer program module and merging the trusted user interface computer program module with its distrusted end user interface;
(e) launch an authentication validation function receiver computer program module on the secure server to ensure secure communications with the trusted user interface computer program module (e.g. JavaScript object) when executing on the end user's computer;
(f) launch an authentication validation function sender computer program module on the trusted user interface computer program module at the end user's computer to ensure secure communications with the secure server;
(g) at periodic intervals, send an outgoing communication from the authentication validation function sender computer program module on the trusted user interface computer program module to the authentication validation function receiver computer program module on the secure server via the data communications interface, the outgoing communication including a request for contemporary specific attribute parameters of the trusted user interface computer program module;
(h) execute the trusted user interface function computer program module to receive the sensitive information input by the end user;
(i) execute a transaction processing function computer process module of the secure server to receive the sensitive information from the trusted user interface computer program module and provide the sensitive information to the third party data processor;
(j) execute a third party data communication function computer program module on the secure server to receive results data from the third party data processor in response to processing the sensitive data;
(k) execute a signaling function computer program module on the secure server to process the results data;
(l) execute a transaction completion function computer program module on the secure server in response to said results data indicating completion of the third party data processing function; and
(m) send non-sensitive results data from the secure server to the trusted user interface computer program module and then to the distrusted end user interface of the publisher.

2. The system of claim 1, wherein the incoming communication (URL submission) from the calling function computer program module of the publisher includes:
(i) authentication information identifying the publisher (e.g. name, password);
(ii) a request by a publisher for trusted transaction processing services from the security function computer program module; and
(iii) specific parameters provided by the publisher for use in connection with a trusted transaction processing request (e.g. transaction type, service requirements, etc.).

3. The system of claim 1, wherein the trusted transaction interface function computer program module is further operative to:
(i) create a trusted user interface function computer program module (e.g. a JavaScript object);
(ii) configure the trusted user interface function computer program module to contain unpopulated data fields pertinent to the transaction request (e.g. user first name, user last name, credit card number, expiration date, etc.);
(iii) configure the trusted user interface function computer program module to include an unpopulated endpoint authentication key data field (e.g. a data field used to store authentication key data values associated with an authentication key exchange protocol); and
(iv) transform the untrusted computing environment containing the designated host container (iFrame) to display the secure, generated payment form.

4. The system of claim 1, wherein the distrusted server of the publisher includes a distrusted transaction function computer program module operative to:
(i) receive the incoming communication (URL GET) from the secure server via the data communications interface, the incoming communication including the trusted user interface computing object;
(ii) encapsulate the trusted user interface function computer program module within the user interface of the distrusted server of the publisher, in a manner that transforms the distrusted server. (e.g. merge the trusted user interface function computer program module into the distrusted server user interface via an HTML I-frame construct, a programmatic interface, etc.); and
(iii) apply a logical computing segmentation of the web browser between the trusted user interface function computer program module and designated elements of the distrusted server of the publisher (e.g. for example, but not by way of limitation, apply logical domain segmentation controls of a web browser that prevent cross site scripting functions that could maliciously intercept, observe and/or access credit card data fields within the web application interface.

5. The system of claim 1, wherein the authentication validation function receiver computer program module on the secure server is operative to:
(i) calculate an authentication key data value object and store this value in memory;
(ii) send, via the data communications interface, an identical copy of the authentication key data value object to the trusted user interface function computer program module and store this value within the authentication key data field of the trusted user interface computing object;
(iii) at periodic intervals, calculate a new authentication key data value object that supersedes the preceding authentication key data value object;
(iv) replace the obsolete authentication key data value object stored in memory with the superseding value object;
(v) send, via the data communications interface, an identical copy of the superseding authentication key data value object to the trusted user interface function computer program module and replace the obsolete stored authentication key data value object of the trusted user interface function computer program module with the superseding value;
(vi) at periodic intervals, execute a query function computer process module of the secure server to retrieve, via the data communications interface, the current stored authentication key data value object of the trusted user interface function computer program module;
(vii) subsequent to the completion of the computing query function, execute a computing identity validation process to compare the retrieved authentication key data value object of the trusted user interface function computer program module to the current stored authentication key data value object of the secure server;
(viii) generate an identity validation result signal that contains the results of the identity validation process;
(ix) present the identity validation result signal to designated recipients of the secure server; and
(x) a gatekeeping process of the secure server configured to receive the identity validation result signal and execute a predefined algorithm designated to correspond with the received identity validation result signal. (e.g. allow data communications to and from the trusted user interface function computer program module in the event of successful in point validation, block data communications to and from the trusted user interface function computer program module and issue an alert signal in the event of an identity validation failure, etc.).

6. The system of claim 1, wherein the authentication validation function sender computer program module on the trusted user interface computer program module at the end user's computer is operative to:
(i) receive from the secure server, via the data communications interface, an authentication key data value object and store this value in memory;
(ii) at periodic intervals, receive from the secure server, via the data communications interface, a superseding authentication key data value object which replaces the obsolete preceding authentication key data value object stored in memory;
(iii) at periodic intervals, execute a query function computer process module of the trusted user interface function computer program module to retrieve, via the data communications interface, the current stored authentication key data value object of the secure server;
(iv) subsequent to the completion of the query function, execute an identity validation function computer process module to compare the retrieved authentication key data value object of the secure server to the current stored authentication key data value object of the trusted user interface function computer program module;
(v) generate identity validation result signal (e.g. signal that both endpoints are authenticated, one failed to authenticate, both failed to authenticate, etc.); and
(vi) a gatekeeping process of the trusted user interface function computer program module configured to receive the identity validation result signal and execute a predefined algorithm designated to correspond with the received identity validation result signal. (e.g. allow data communications to and from the secure server in the event of successful in point validation, block data communications.

7. The system of claim 1, wherein the authentication validation function receiver computer program module executable on the secure server is operative to:
(i) receive, via the data communications interface, the contemporary specific attribute parameters of the publisher calling function computer program module;
(ii) calculate a hash value derived from the contemporary specific attribute parameters of the publisher calling function computer program module; and
(iii) compare the contemporary calculated hash value with the original calculated hash value stored in memory.

8. The system of claim 1, wherein the trusted user interface function computer program module on the end user's computer is further operative to:
(i) request exclusive data entry and process control from the distrusted server of the publisher;
(ii) acquire and retain exclusive data entry and process control from the distrusted server of the publisher (e.g. such that the distrusted server is unable to receive or process and user data and instructions until control has been released by the trusted user interface, etc.);
(iii) receive data values entered by the end-user via the trusted data communications conduit; and
(iv) send an outgoing communication (asynchronous JavaScript request) from the trusted user interface function computer program module to the secure server via the data communications interface, the outgoing communication including data values and parameters associated with the transaction (e.g. user names, credit card number, health records, etc.).

9. The system of claim 1, wherein the transaction processing computer program module of the secure server is further operative to:
(i) receive an incoming communication (asynchronous JavaScript response) from the trusted user interface function computer program module via the data communications interface, the incoming communications including the data values and parameters associated with the transaction; and
(ii) assemble and store in the memory third party data processing information required by the third party data processor for use in providing the trusted computing function, the third party data processing information comprising the specific data provided by the publisher and any specific additional data input by the end user.

10. The system of claim 1, wherein the third party data communication function computer program module executable on the secure server is further operative to:
(i) send an outgoing communication (server side HTTP request) to the third-party data processor, via the data communications interface, the outgoing communication including the third party data processing information; and
(ii) receive an incoming communication (server side HTTP response) via the data communications interface, the incoming communication including results data from the third party data processor.

11. The system of claim 1, wherein the signaling computer program module is further operative to:
(i) parse the third party data processor results and extract a transaction error signal (e.g. requests for data correction, incremental information, etc.);
(ii) generate a third-party data processor transaction error signal; and
(iii) present the third-party data processor transaction error signal to designated computer program modules of the secure server.

12. The system of claim 1, wherein the transaction completion function computer program module on the secure server is further operative to:
(i) receive third-party data processor results from the third-party data communication function computer program module;
(ii) receive third-party data processor transaction error signal from the transaction result signaling function computer program module;
(iii) assemble and store in memory the third-party data processor results, transaction error signals and parameter values associated with the trusted computing process (e.g. transaction result codes, error codes, etc.);
(iv) execute a response function computer program module designated to correspond with the received third-party data processor results and third-party data processor transaction error signals (e.g. complete the transaction, request error corrections, etc.);
(v) send an outgoing signal communication (server side HTTP request) to the publisher, via the data communications interface, the outgoing signal including the third-party data processor results, transaction error signals and parameter values associated with the trusted computing;
(vi) send an outgoing signal communication (embedded URL GET) to the end-user, via the data communications interface, the outgoing signal including the third-party data processor results, transaction error signals and parameter values associated with the trusted computing process;
(vii) upon demand from the trusted user interface function computer program module, execute an error response loop function computer process module of the secure server, the error response loop computer process module operative to:
(1) receive an incoming communication (asynchronous JavaScript request) from the trusted user interface function computer program module via the data communications interface, the incoming communications including incremental data values and parameters requested by the response function computer program module (e.g. the supplemental data values and parameters including items such as error corrections);
(2) launch the third party data communication function computer program module of the secure server;
(3) send an outgoing communication (asynchronous JavaScript response) to the third-party data processor, via the data communications interface, the outgoing communication including the incremental data values and parameters associated with the trusted computing process;
(4) restart the process flow of the transaction completion computer process module;
(viii) generate a transaction complete signal, the signal including markers to indicate termination of the trusted computing process;
(ix) present the transaction completion signal to the trusted user interface function computer module of the publisher, via the data communications interface;
(x) generate an interface release control signal, the signal instructing the trusted user interface function computer program module to release data input and process control rights to the publisher;
(xi) present the interface release control signal to the trusted user interface function computer program module, via the data communications interface.

13. A computer-implemented method for providing a trusted computing function of a third party data processor on behalf of a networked publisher in connection with providing a networked computing function for an end user by the publisher, the third party data processor requiring sensitive information of an end user, the publisher operating a distrusted server coupled to a data communication network, the distrusted server including a distrusted end user interface, a processor for executing computer program modules and a memory; comprising the computer-implemented steps of:
providing a secure server coupled to the data communications network, the secure server including a processor for executing computer program modules and a memory;
providing a data communications interface for trusted communications between the distrusted server of the publisher and an end user, trusted communications between the distrusted server of the publisher and the secure server, and trusted communications between the secure server and the third party data processor; and
providing a security function computer program module executable on the secure server, the security function program module operative to:
(a) receive an incoming communication (URL submission) from a calling function computer program module of the publisher via the data communications interface;
(b) receive an incoming communication from the publisher via the data communications interface, the incoming communication including contemporary specific attribute parameters of the calling function computer program module of the publisher;
(c) execute a trusted transaction interface function computer program module on the secure server to create a trusted user interface computer program module executable on an end user's computer (e.g. JavaScript object);
(d) send an outgoing communication from the security function computer program module to the publisher via the data communications interface, the outgoing communication including the trusted user interface computer program module (e.g. the JavaScript object), the calling function computer program module of the publisher receiving the trusted user interface computer program module and merging the trusted user interface computer program module with its distrusted end user interface;
(e) launch an authentication validation function receiver computer program module on the secure server to ensure secure communications with the trusted user interface computer program module (e.g. JavaScript object) when executing on the end user's computer;
(f) launch an authentication validation function sender computer program module on the trusted user interface computer program module at the end user's computer to ensure secure communications with the secure server;
(g) at periodic intervals, send an outgoing communication from the authentication validation function sender computer program module on the trusted user interface computer program module to the authentication validation function receiver computer program module on the secure server via the data communications interface, the outgoing communication including a request for contemporary specific attribute parameters of the trusted user interface computer program module;
(h) execute the trusted user interface function computer program module to receive the sensitive information input by the end user;
(i) execute a transaction processing function computer process module of the secure server to receive the sensitive information from the trusted user interface computer program module and provide the sensitive information to the third party data processor;
(j) execute a third party data communication function computer program module on the secure server to receive results data from the third party data processor in response to processing the sensitive data;
(k) execute a signaling function computer program module on the secure server to process the results data;
(l) execute a transaction completion function computer program module on the secure server in response to said results data indicating completion of the third party data processing function; and
(m) send non-sensitive results data from the secure server to the trusted user interface computer program module and then to the distrusted end user interface of the publisher.

14. The method of claim 13, wherein the incoming communication (URL submission) from the calling function computer program module of the publisher includes:
(i) authentication information identifying the publisher (e.g. name, password);
(ii) a request by a publisher for trusted transaction processing services from the security function computer program module; and
(iii) specific parameters provided by the publisher for use in connection with a trusted transaction processing request (e.g. transaction type, service requirements, etc.).

15. The method of claim 13, wherein the trusted transaction interface function computer program module is further operative to:
(i) create a trusted user interface function computer program module (e.g. a JavaScript object);
(ii) configure the trusted user interface function computer program module to contain unpopulated data fields pertinent to the transaction request (e.g. user first name, user last name, credit card number, expiration date, etc.);
(iii) configure the trusted user interface function computer program module to include an unpopulated endpoint authentication key data field (e.g. a data field used to store authentication key data values associated with an authentication key exchange protocol); and
(iv) transform the untrusted computing environment containing the designated host container (iFrame) to display the secure, generated payment form.

16. The method of claim 13, wherein the distrusted server of the publisher includes a distrusted transaction function computer program module operative to:
(i) receive the incoming communication (URL GET) from the secure server via the data communications interface, the incoming communication including the trusted user interface computing object;
(ii) encapsulate the trusted user interface function computer program module within the user interface of the distrusted server of the publisher, in a manner that transforms the distrusted server. (e.g. merge the trusted user interface function computer program module into the distrusted server user interface via an HTML I-frame construct, a programmatic interface, etc.); and
(iii) apply a logical computing segmentation of the web browser between the trusted user interface function computer program module and designated elements of the distrusted server of the publisher (e.g. for example, but not by way of limitation, apply logical domain segmentation controls of a web browser that prevent cross site scripting functions that could maliciously intercept, observe and/or access credit card data fields within the web application interface.

17. The method of claim 13, wherein the authentication validation function receiver computer program module on the secure server is operative to:
(i) calculate an authentication key data value object and store this value in memory;
(ii) send, via the data communications interface, an identical copy of the authentication key data value object to the trusted user interface function computer program module and store this value within the authentication key data field of the trusted user interface computing object;
(iii) at periodic intervals, calculate a new authentication key data value object that supersedes the preceding authentication key data value object;
(iv) replace the obsolete authentication key data value object stored in memory with the superseding value object;
(v) send, via the data communications interface, an identical copy of the superseding authentication key data value object to the trusted user interface function computer program module and replace the obsolete stored authentication key data value object of the trusted user interface function computer program module with the superseding value;
(vi) at periodic intervals, execute a query function computer process module of the secure server to retrieve, via the data communications interface, the current stored authentication key data value object of the trusted user interface function computer program module;
(vii) subsequent to the completion of the computing query function, execute a computing identity validation process to compare the retrieved authentication key data value object of the trusted user interface function computer program module to the current stored authentication key data value object of the secure server;
(viii) generate an identity validation result signal that contains the results of the identity validation process;
(ix) present the identity validation result signal to designated recipients of the secure server; and
(x) a gatekeeping process of the secure server configured to receive the identity validation result signal and execute a predefined algorithm designated to correspond with the received identity validation result signal. (e.g. allow data communications to and from the trusted user interface function computer program module in the event of successful in point validation, block data communications to and from the trusted user interface function computer program module and issue an alert signal in the event of an identity validation failure, etc.).

18. The method of claim 13, wherein the authentication validation function sender computer program module on the trusted user interface computer program module at the end user's computer is operative to:
(i) receive from the secure server, via the data communications interface, an authentication key data value object and store this value in memory;
(ii) at periodic intervals, receive from the secure server, via the data communications interface, a superseding authentication key data value object which replaces the obsolete preceding authentication key data value object stored in memory;
(iii) at periodic intervals, execute a query function computer process module of the trusted user interface function computer program module to retrieve, via the data communications interface, the current stored authentication key data value object of the secure server;
(iv) subsequent to the completion of the query function, execute an identity validation function computer process module to compare the retrieved authentication key data value object of the secure server to the current stored authentication key data value object of the trusted user interface function computer program module;
(v) generate identity validation result signal (e.g. signal that both endpoints are authenticated, one failed to authenticate, both failed to authenticate, etc.); and
(vi) a gatekeeping process of the trusted user interface function computer program module configured to receive the identity validation result signal and execute a predefined algorithm designated to correspond with the received identity validation result signal. (e.g. allow data communications to and from the secure server in the event of successful in point validation, block data communications.

19. The method of claim 13, wherein the authentication validation function receiver computer program module executable on the secure server is operative to:
(i) receive, via the data communications interface, the contemporary specific attribute parameters of the publisher calling function computer program module;
(ii) calculate a hash value derived from the contemporary specific attribute parameters of the publisher calling function computer program module; and
(iii) compare the contemporary calculated hash value with the original calculated hash value stored in memory.

20. The method of claim 13, wherein the trusted user interface function computer program module on the end user's computer is further operative to:
(i) request exclusive data entry and process control from the distrusted server of the publisher;
(ii) acquire and retain exclusive data entry and process control from the distrusted server of the publisher (e.g. such that the distrusted server is unable to receive or process and user data and instructions until control has been released by the trusted user interface, etc.);
(iii) receive data values entered by the end-user via the trusted data communications conduit; and
(iv) send an outgoing communication (asynchronous JavaScript request) from the trusted user interface function computer program module to the secure server via the data communications interface, the outgoing communication including data values and parameters associated with the transaction (e.g. user names, credit card number, health records, etc.).

21. The method of claim 13, wherein the transaction processing computer program module of the secure server is further operative to:
(i) receive an incoming communication (asynchronous JavaScript response) from the trusted user interface function computer program module via the data communications interface, the incoming communications including the data values and parameters associated with the transaction; and
(ii) assemble and store in the memory third party data processing information required by the third party data processor for use in providing the trusted computing function, the third party data processing information comprising the specific data provided by the publisher and any specific additional data input by the end user.

22. The method of claim 13, wherein the third party data communication function computer program module executable on the secure server is further operative to:
(i) send an outgoing communication (server side HTTP request) to the third-party data processor, via the data communications interface, the outgoing communication including the third party data processing information; and
(ii) receive an incoming communication (server side HTTP response) via the data communications interface, the incoming communication including results data from the third party data processor.

23. The method of claim 13, wherein the signaling computer program module is further operative to:
(i) parse the third party data processor results and extract a transaction error signal (e.g. requests for data correction, incremental information, etc.);
(ii) generate a third-party data processor transaction error signal; and
(iii) present the third-party data processor transaction error signal to designated computer program modules of the secure server.

24. The method of claim 13, wherein the transaction completion function computer program module on the secure server is further operative to:
(i) receive third-party data processor results from the third-party data communication function computer program module;
(ii) receive third-party data processor transaction error signal from the transaction result signaling function computer program module;
(iii) assemble and store in memory the third-party data processor results, transaction error signals and parameter values associated with the trusted computing process (e.g. transaction result codes, error codes, etc.);
(iv) execute a response function computer program module designated to correspond with the received third-party data processor results and third-party data processor transaction error signals (e.g. complete the transaction, request error corrections, etc.);
(v) send an outgoing signal communication (server side HTTP request) to the publisher, via the data communications interface, the outgoing signal including the third-party data processor results, transaction error signals and parameter values associated with the trusted computing;
(vi) send an outgoing signal communication (embedded URL GET) to the end-user, via the data communications interface, the outgoing signal including the third-party data processor results, transaction error signals and parameter values associated with the trusted computing process;
(vii) upon demand from the trusted user interface function computer program module, execute an error response loop function computer process module of the secure server, the error response loop computer process module operative to:
(1) receive an incoming communication (asynchronous JavaScript request) from the trusted user interface function computer program module via the data communications interface, the incoming communications including incremental data values and parameters requested by the response function computer program module (e.g. the supplemental data values and parameters including items such as error corrections);
(2) launch the third party data communication function computer program module of the secure server;
(3) send an outgoing communication (asynchronous JavaScript response) to the third-party data processor, via the data communications interface, the outgoing communication including the incremental data values and parameters associated with the trusted computing process;
(4) restart the process flow of the transaction completion computer process module;
(viii) generate a transaction complete signal, the signal including markers to indicate termination of the trusted computing process;
(ix) present the transaction completion signal to the trusted user interface function computer module of the publisher, via the data communications interface;
(x) generate an interface release control signal, the signal instructing the trusted user interface function computer program module to release data input and process control rights to the publisher;
(xi) present the interface release control signal to the trusted user interface function computer program module, via the data communications interface.

25. A system for providing a trusted computing function of a third party data processor on behalf of a networked publisher in connection with providing a networked computing function for an end user by the publisher, the publisher operating a distrusted server coupled to a data communication network, the distrusted server including a user interface, a processor for executing computer program modules and a memory; the system comprising:
a secure server coupled to the data communications network, the secure server including a processor for executing computer program modules and a memory;
a data communications interface for trusted communications between the distrusted server of the publisher and an end user, the end user being associated with the publisher, trusted communications between the distrusted server of the publisher and the secure server, and trusted communications between the secure server and the third party data processor; and
a security function computer program module executable on the secure server, the security function program module operative to:
(a) receive an incoming communication (URL submission) from a calling function computer program module of the publisher via the data communications interface, the incoming communication including:
(i) authentication information identifying the publisher (e.g. name, password);
(ii) a request by a publisher for trusted transaction processing services from the security function computer program module; and
(iii) specific parameters provided by the publisher for use in connection with a trusted transaction processing request (e.g. transaction type, service requirements, etc.);
(b) launch a trusted transaction interface function computer program module executable on the secure server, the trusted transaction interface function computer program module operative to:
(i) create a trusted user interface function computer program module (e.g. a JavaScript object);
(ii) configure the trusted user interface function computer program module to contain unpopulated data fields pertinent to the transaction request (e.g. user first name, user last name, credit card number, expiration date, etc.);
(iii) configure the trusted user interface function computer program module to include an unpopulated endpoint authentication key data field (e.g. a data field used to store authentication key data values associated with an authentication key exchange protocol);
(iv) transform the untrusted computing environment containing the designated host container (iFrame) to display the secure, generated payment form;
(c) send an outgoing communication (any outgoing interface, e.g. form data post, e-mail, server side HTTP response, URL GET, etc.) from the security function computer program module to the publisher via the data communications interface, the outgoing communication including the trusted user interface computing object;
(d) launch a trusted transaction function computer program module of the publisher, on a secure server, the trusted transaction function computer program module operative to:
(i) receive an incoming communication (URL GET) from the secure server via the data communications interface, the incoming communication including the trusted user interface computing object;
(ii) encapsulate the trusted user interface function computer program module within the user interface of the distrusted server of the publisher, in a manner that transforms the distrusted server. (e.g. merge the trusted user interface function computer program module into the distrusted server user interface via an HTML I-frame construct, a programmatic interface, etc.);
(iii) apply a logical computing segmentation of the web browser between the trusted user interface function computer program module and designated elements of the distrusted server of the publisher (e.g. for example, but not by way of limitation, apply logical domain segmentation controls of a web browser that prevent cross site scripting functions that could maliciously intercept, observe and/or access credit card data fields within the web application interface;
(e) launch an identity validation function computer program module executable on the secure server, the identity validation computer program module operative to:
(i) calculate an authentication key data value object and store this value in memory;
(ii) send, via the data communications interface, an identical copy of the authentication key data value object to the trusted user interface function computer program module and store this value within the authentication key data field of the trusted user interface computing object;
(iii) at periodic intervals, calculate a new authentication key data value object that supersedes the preceding authentication key data value object;
(iv) replace the obsolete authentication key data value object stored in memory with the superseding value object;
(v) send, via the data communications interface, an identical copy of the superseding authentication key data value object to the trusted user interface function computer program module and replace the obsolete stored authentication key data value object of the trusted user interface function computer program module with the superseding value;
(vi) at periodic intervals, execute a query function computer process module of the secure server to retrieve, via the data communications interface, the current stored authentication key data value object of the trusted user interface function computer program module;
(vii) subsequent to the completion of the computing query function, execute a computing identity validation process to compare the retrieved authentication key data value object of the trusted user interface function computer program module to the current stored authentication key data value object of the secure server;
(viii) generate an identity validation result signal that contains the results of the identity validation process;
(ix) present the identity validation result signal to designated recipients of the secure server;
(x) a gatekeeping process of the secure server configured to receive the identity validation result signal and execute a predefined algorithm designated to correspond with the received identity validation result signal. (e.g. allow data communications to and from the trusted user interface function computer program module in the event of successful in point validation, block data communications to and from the trusted user interface function computer program module and issue an alert signal in the event of an identity validation failure, etc.);
(f) launch an identity validation function computer program module executable on trusted user interface computing object, the identity validation module operative to:
(i) receive from the secure server, via the data communications interface, an authentication key data value object and store this value in memory;
(ii) at periodic intervals, receive from the secure server, via the data communications interface, a superseding authentication key data value object which replaces the obsolete preceding authentication key data value object stored in memory;
(iii) at periodic intervals, execute a query function computer process module of the trusted user interface function computer program module to retrieve, via the data communications interface, the current stored authentication key data value object of the secure server;
(iv) subsequent to the completion of the query function, execute an identity validation function computer process module to compare the retrieved authentication key data value object of the secure server to the current stored authentication key data value object of the trusted user interface function computer program module;
(v) generate identity validation result signal (e.g. signal that both endpoints are authenticated, one failed to authenticate, both failed to authenticate, etc.);
(vi) a gatekeeping process of the trusted user interface function computer program module configured to receive the identity validation result signal and execute a predefined algorithm designated to correspond with the received identity validation result signal. (e.g. allow data communications to and from the secure server in the event of successful in point validation, block data communications;
(g) at periodic intervals, send an outgoing communication (asynchronous JavaScript response) from the security function computer program module to the publisher via the data communications interface, the outgoing communication including a request for the contemporary specific attribute parameters of the publisher calling function computer program module (e.g. the byte count and current file date of the object as they exist at the time of the request, etc.);
(h) receive an incoming communication (asynchronous JavaScript request) from the publisher via the data communications interface, the incoming communication including the contemporary specific attribute parameters of the publisher calling function computer program module (e.g. byte count and file date of the object, etc.);
(i) launch an authentication function computer program module executable on the secure server, the authentication module operative to:
(i) receive, via the data communications interface, the contemporary specific attribute parameters of the publisher calling function computer program module;
(ii) calculate a hash value derived from the contemporary specific attribute parameters of the publisher calling function computer program module;
(iii) compare the contemporary calculated hash value with the original calculated hash value stored in memory;
(j) execute the trusted user interface function computer program module, the trusted user interface function computer program module operative to:
(i) request exclusive data entry and process control from the distrusted server of the publisher;
(ii) acquire and retain exclusive data entry and process control from the distrusted server of the publisher (e.g. such that the distrusted server is unable to receive or process and user data and instructions until control has been released by the trusted user interface, etc.);
(iii) receive data values entered by the end-user via the trusted data communications conduit;
(iv) send an outgoing communication (asynchronous JavaScript request) from the trusted user interface function computer program module to the secure server via the data communications interface, the outgoing communication including data values and parameters associated with the transaction (e.g. user names, credit card number, health records, etc.);
(k) launch a transaction processing function computer program module of the secure server, the transaction hosting computer process module operative to:
(i) receive an incoming communication (asynchronous JavaScript response) from the trusted user interface function computer program module via the data communications interface, the incoming communications including the data values and parameters associated with the transaction;
(ii) assemble and store in the memory third party data processing information required by the third party data processor for use in providing the trusted computing function, the third party data processing information comprising the specific data provided by the publisher and any specific additional data input by the end user;
(l) launch a third party data communication function computer program module executable on the secure server, the third party data communication computer program module operative to:
(i) send an outgoing communication (server side HTTP request) to the third-party data processor, via the data communications interface, the outgoing communication including the third party data processing information;
(ii) receive an incoming communication (server side HTTP response) via the data communications interface, the incoming communication including results data from the third party data processor;
(m) launch an error signaling function computer program module of the secure server, the error signaling computer program module operative to:
(i) parse the third party data processor results and extract transaction error signals (e.g. requests for data correction, incremental information, etc.);
(ii) generate a third-party data processor transaction error signal;
(iii) present the third-party data processor transaction error signal to designated computer program modules of the secure server;
(n) launch a transaction completion function computer program module executable on the secure server, the transaction completion computer program module operative to:
(i) receive third-party data processor results from the third-party data communication function computer program module;
(ii) receive third-party data processor transaction error signal from the transaction result signaling function computer program module;
(iii) assemble and store in memory the third-party data processor results, transaction error signals and parameter values associated with the trusted computing process (e.g. transaction result codes, error codes, etc.);
(iv) execute a response function computer program module designated to correspond with the received third-party data processor results and third-party data processor transaction error signals (e.g. complete the transaction, request error corrections, etc.);
(v) send an outgoing signal communication (server side HTTP request) to the publisher, via the data communications interface, the outgoing signal including the third-party data processor results, transaction error signals and parameter values associated with the trusted computing;
(vi) send an outgoing signal communication (embedded URL GET) to the end-user, via the data communications interface, the outgoing signal including the third-party data processor results, transaction error signals and parameter values associated with the trusted computing process;
(vii) upon demand from the trusted user interface function computer program module, execute an error response loop function computer process module of the secure server, the error response loop computer process module operative to:
(1) receive an incoming communication (asynchronous JavaScript request) from the trusted user interface function computer program module via the data communications interface, the incoming communications including incremental data values and parameters requested by the response function computer program module (e.g. the supplemental data values and parameters including items such as error corrections);
(2) launch the third party data communication function computer program module of the secure server;
(3) send an outgoing communication (asynchronous JavaScript response) to the third-party data processor, via the data communications interface, the outgoing communication including the incremental data values and parameters associated with the trusted computing process;
(4) restart the process flow of the transaction completion computer process module;
(viii) generate a transaction complete signal, the signal including markers to indicate termination of the trusted computing process;
(ix) present the transaction completion signal to the trusted user interface function computer module of the publisher, via the data communications interface;
(x) generate an interface release control signal, the signal instructing the trusted user interface function computer program module to release data input and process control rights to the publisher;
(xi) present the interface release control signal to the trusted user interface function computer program module, via the data communications interface.

26. The system of claim 25, wherein the publisher is a merchant with an online shopping cart as the publisher's business process, and wherein the third party data processor is a financial institution that provides a trusted payment function such credit card processing of the end user's credit card information.

27. The system of claim 25, wherein the publisher is a health care services provider with an online health care information web site, and wherein the third party data processor is a health insurance provider that provides a trusted (HIPAA compliant) health care information gathering function from the end user.

28. The system of claim 25, wherein the publisher is a data warehousing services provider, and wherein the third party data processor is a provider of trusted data management services.

29. The system of claim 25, wherein the trusted user interface function computer program module is an I-frame construct defined in hypertext markup language (HTML).

30. The system of claim 25, wherein the trusted user interface function computer program module is a programmatic construct (e.g. a JavaScript object, ActiveX control, PHP script, compiled executable file, etc.)

31. A computer-implemented method for providing a trusted computing function of a third party data processor on behalf of a networked publisher in connection with providing a networked computing function for an end user by the publisher, the publisher operating a distrusted server coupled to a data communication network, the distrusted server including a user interface, a processor for executing computer program modules, and a memory; the method comprising the steps of:
providing a secure server coupled to a data communications network, the secure server including a processor for executing computer program modules and a memory;
providing a data communications interface for trusted communications between the distrusted server of the publisher and an end user, the end user being associated with the publisher, trusted communications between the distrusted server of the publisher and the secure server, and trusted communications between the secure server and the third party data processor; and
providing a security function computer program module executable on the secure server, the security function program module operative to:
(a) receive an incoming communication (URL submission) from a calling function computer program module of the publisher via the data communications interface, the incoming communication including:
(i) authentication information identifying the publisher (e.g. name, password);
(ii) a request by a publisher for trusted transaction processing services from the security function computer program module;
(iii) specific parameters provided by the publisher for use in connection with a trusted transaction processing request (e.g. transaction type, service requirements, etc.);
(b) launch an authentication function computer program module executable on the secure server, the authentication function program module operative to:
(i) send an outgoing communication (server side HTTP request) from the security function computer program module to the publisher via the data communications interface, the outgoing communication including a request for specific attribute parameters of the publisher calling object computer module initiating the trusted transaction processing request (e.g. byte count and file date of the calling object as they exist at the time of the request, etc.);
(ii) receive an incoming communication (server side HTTP response) from the publisher via the data communications interface, the incoming communication including the requested specific attribute parameters of the publisher calling function computer program module (e.g. the then-current byte count and file date of the publisher object initiating the trusted transaction processing request, etc.);
(iii) calculate a hash value derived from the request specific attribute parameters of the publisher calling function computer program module;
(iv) store the calculated hash value in memory;
(v) periodically send an outgoing communication (server side HTTP request) from the security function computer program module to the publisher via the data communications interface, the outgoing communication including a request for the contemporary specific attribute parameters of the publisher calling function computer program module (e.g. the current point-in-time byte count and current file date of the object as they exist at the time of the request, etc.);
(vi) receive an incoming communication (server side HTTP response) from the publisher via the data communications interface, the incoming communication including the contemporary specific attribute parameters of the publisher calling function computer program module (e.g. byte count and file date of the object, etc.);
(vii) calculate a hash value derived from the contemporary specific attribute parameters of the publisher calling function computer program module;
(viii) compare the calculated hash value of the contemporary publisher calling object with the hash value of the original calculated publisher calling object stored in memory;
(ix) determine if the contemporary calculated hash value is identical to the original calculated hash value;
(c) launch a signaling function computer program module executable on the secure server, the signaling function computer program module operative to:
(i) receive the results of the publisher calling object hash value comparison;
(ii) generate a publisher calling object authentication result signal (e.g. signal that contemporary calling object hash value failed authentication, passed authentication, etc.);
(iii) present the publisher calling object authentication result signal to designated computing process modules of the secure server;
(iv) send an outgoing communication to the publisher, via the data communications interface, the outgoing communication including publisher calling object authentication result signal;
(d) launch a gatekeeper function computer program module executable on the secure server, the gatekeeper computer program module operative to:
(i) receive the authentication result signal of the authentication function computer program module;
(ii) execute a response function computer program module designated to correspond with the received authentication result signal value (e.g. deny traffic via the data communications interface in the event the contemporary publisher computer calling object fails to authenticate);
(e) launch a trusted transaction interface function computer program module executable on the secure server, the trusted transaction interface function computer program module operative to:
(i) create a trusted user interface function computer program module (e.g. a JavaScript object);
(ii) configure the trusted user interface function computer program module to contain unpopulated data fields pertinent to the transaction request (e.g. user first name, user last name, credit card number, expiration date, etc.);
(iii) configure the trusted user interface function computer program module to include an unpopulated endpoint authentication key data field (e.g. a data field used to store authentication key data values associated with an authentication key exchange protocol);
(f) send an outgoing communication (any outgoing interface, e.g. form data post, e-mail, server side HTTP response, URL GET, etc.) from the security function computer program module to the publisher via the data communications interface, the outgoing communication including the trusted user interface computing object;
(g) launch a trusted transaction function computer program module of the publisher, the trusted transaction function computer program module operative to:
(i) receive an incoming communication (URL GET) from the secure server via the data communications interface, the incoming communication including the trusted user interface computing object;
(ii) encapsulate the trusted user interface function computer program module within the user interface of the distrusted server of the publisher (e.g. merge the trusted user interface function computer program module into the distrusted server user interface via an HTML I-frame construct, a programmatic interface, etc.);
(iii) create logical computing segmentation between the trusted user interface function computer program module and designated elements of the distrusted server of the publisher (e.g. create a logical computer boundary around the trusted user interface function computer program module that prevents unauthorized elements of the distrusted server from intercepting, observing and/or accessing data fields within the trusted user interface computing object, etc.)
(iv) create a trusted data communications conduit between the end user and the trusted user interface function computer program module with logical computing segmentation between the trusted data communications conduit and designated elements of the distrusted server of the publisher. (e.g. create a logical computer boundary around the trusted data communications link between the end-user and the trusted user interface computing object, so that that elements of the distrusted server are prevented from intercepting, observing and/or accessing attributes and contents of the trusted data communications flow, etc.);
(h) launch an identity validation function computer program module executable on the secure server, the identity validation computer program module operative to:
(i) calculate an authentication key data value object and store this value in memory;
(ii) send, via the data communications interface, an identical copy of the authentication key data value object to the trusted user interface function computer program module and store this value within the authentication key data field of the trusted user interface computing object;
(iii) at periodic intervals, calculate a new authentication key data value object that supersedes the preceding authentication key data value object;
(iv) replace the obsolete authentication key data value object stored in memory with the superseding value object;
(v) send, via the data communications interface, an identical copy of the superseding authentication key data value object to the trusted user interface function computer program module and replace the obsolete stored authentication key data value object of the trusted user interface function computer program module with the superseding value;
(vi) at periodic intervals, execute a query function computer process module of the secure server to retrieve, via the data communications interface, the current stored authentication key data value object of the trusted user interface function computer process module;
(vii) subsequent to the completion of the computing query function, execute a computing identity validation process to compare the retrieved authentication key data value object of the trusted user interface function computer program module to the current stored authentication key data value object of the secure server;
(viii) generate an identity validation result signal that contains the results of the identity validation process;
(ix) present the identity validation result signal to designated recipients of the secure server;
(x) a gatekeeping process of the secure server configured to receive the identity validation result signal and execute a predefined algorithm designated to correspond with the received identity validation result signal. (e.g. allow data communications to and from the trusted user interface function computer program module in the event of successful in point validation, block data communications to and from the trusted user interface function computer program module and issue an alert signal in the event of an identity validation failure, etc.);
(i) launch an identity validation function computer program module executable on trusted user interface computing object, the identity validation module operative to:
(i) receive from the secure server, via the data communications interface, an authentication key data value object and store this value in memory;
(ii) at periodic intervals, receive from the secure server, via the data communications interface, a superseding authentication key data value object which replaces the obsolete preceding authentication key data value object stored in memory;
(iii) at periodic intervals, execute a query function computer process module of the trusted user interface function computer program module to retrieve, via the data communications interface, the current stored authentication key data value object of the secure server;
(iv) subsequent to the completion of the query function, execute an identity validation function computer process module to compare the retrieved authentication key data value object of the secure server to the current stored authentication key data value object of the trusted user interface function computer program module;
(v) generate identity validation result signal (e.g. signal that both endpoints are authenticated, one failed to authenticate, both failed to authenticate, etc.);
(vi) a gatekeeping process of the trusted user interface function computer program module configured to receive the identity validation result signal and execute a predefined algorithm designated to correspond with the received identity validation result signal. (e.g. allow data communications to and from the secure server in the event of successful in point validation, block data communications;
(j) at periodic intervals, send an outgoing communication (asynchronous JavaScript response) from the security function computer program module to the publisher via the data communications interface, the outgoing communication including a request for the contemporary specific attribute parameters of the publisher calling function computer program module (e.g. the byte count and current file date of the object as they exist at the time of the request, etc.);
(k) receive an incoming communication (asynchronous JavaScript request) from the publisher via the data communications interface, the incoming communication including the contemporary specific attribute parameters of the publisher calling function computer program module (e.g. byte count and file date of the object, etc.);
(l) launch an authentication function computer program module executable on the secure server, the authentication module operative to:
(i) receive, via the data communications interface, the contemporary specific attribute parameters of the publisher calling function computer program module;
(ii) calculate a hash value derived from the contemporary specific attribute parameters of the publisher calling function computer program module;
(iii) compare the contemporary calculated hash value with the original calculated hash value stored in memory;
(m) execute the trusted user interface function computer program module, the trusted user interface function computer program module operative to:
(i) request exclusive data entry and process control from the distrusted server of the publisher;
(ii) acquire and retain exclusive data entry and process control from the distrusted server of the publisher (e.g. such that the distrusted server is unable to receive or process and user data and instructions until control has been released by the trusted user interface, etc.);
(iii) receive data values entered by the end-user via the trusted data communications conduit;
(iv) send an outgoing communication (asynchronous JavaScript request) from the trusted user interface function computer program module to the secure server via the data communications interface, the outgoing communication including data values and parameters associated with the transaction (e.g. user names, credit card number, health records, etc.);
(n) Launch a transaction processing function computer process module of the secure server, the transaction hosting computer process module operative to:
(i) receive an incoming communication (asynchronous JavaScript response) from the trusted user interface function computer program module via the data communications interface, the incoming communications including the data values and parameters associated with the transaction;
(ii) assemble and store in the memory third party data processing information required by the third party data processor for use in providing the trusted computing function, the third party data processing information comprising the specific data provided by the publisher and any specific additional data input by the end user;
(o) launch a third party data communication function computer program module executable on the secure server, the third party data communication computer program module operative to:
(i) send an outgoing communication (server side HTTP request) to the third-party data processor, via the data communications interface, the outgoing communication including the third party data processing information;
(ii) receive an incoming communication (server side HTTP response) via the data communications interface, the incoming communication including results data from the third party data processor.
(p) launch an error signaling function computer program module of the secure server, the error signaling computer program module operative to:
(i) parse the third party data processor results and extract transaction error signals (e.g. requests for data correction, incremental information, etc.);
(ii) Generate a third-party data processor transaction error signal;
(iii) Present the third-party data processor transaction error signal to designated computer program modules of the secure server;
(q) launch a transaction completion function computer program module executable on the secure server, the transaction completion computer program module operative to:
(i) receive third-party data processor results from the third-party data communication function computer program module;
(ii) receive third-party data processor transaction error signal from the transaction result signaling function computer program module;
(iii) assemble and store in memory the third-party data processor results, transaction error signals and parameter values associated with the trusted computing process. (e.g. transaction result codes, error codes, etc.);
(iv) execute a response function computer program module designated to correspond with the received third-party data processor results and third-party data processor transaction error signals (e.g. complete the transaction, request error corrections, etc.);
(v) send an outgoing signal communication (server side HTTP request) to the publisher, via the data communications interface, the outgoing signal including the third-party data processor results, transaction error signals and parameter values associated with the trusted computing;
(vi) send an outgoing signal communication (embedded URL GET) to the end-user, via the data communications interface, the outgoing signal including the third-party data processor results, transaction error signals and parameter values associated with the trusted computing process;
(vii) upon demand from the trusted user interface function computer program module, execute an error response loop function computer process module of the secure server, the error response loop computer process module operative to:
(1) receive an incoming communication (asynchronous JavaScript request) from the trusted user interface function computer program module via the data communications interface, the incoming communications including incremental data values and parameters requested by the response function computer program module (e.g. the supplemental data values and parameters including items such as error corrections);
(2) launch the third party data communication function computer program module of the secure server;
(3) send an outgoing communication (asynchronous JavaScript response) to the third-party data processor, via the data communications interface, the outgoing communication including the incremental data values and parameters associated with the trusted computing process;
(4) restart the process flow of the transaction completion computer process module;
(viii) generate a transaction complete signal, the signal including markers to indicate termination of the trusted computing process;
(ix) present the transaction completion signal to the trusted user interface function computer module of the publisher, via the data communications interface;
(x) generate an interface release control signal, the signal instructing the trusted user interface function computer program module to release data input and process control rights to the publisher; and
(xi) present the interface release control signal to the trusted user interface function computer program module, via the data communications interface.

32. The method of claim 31, wherein the publisher is a merchant with an online shopping cart as the publisher's business process, and wherein the third party data processor is a financial institution that provides a trusted payment function such credit card processing of the end user's credit card information.

33. The method of claim 31, wherein the publisher is a health care services provider with an online health care information web site, and wherein the third party data processor is a health insurance provider that provides a trusted (HIPAA compliant) health care information gathering function from the end user.

34. The method of claim 31, wherein the publisher is a data warehousing services provider, and wherein the third party data processor is a provider of trusted data management services.

35. The method of claim 31, wherein the trusted user interface function computer program module is an I-frame construct defined in hypertext markup language (HTML).

36. The method of claim 31, wherein the trusted user interface function computer program module is a programmatic construct (e.g. a JavaScript object, ActiveX control, PHP script, compiled executable file, etc.)
